(19) United States
(12) Patent Application Publication
(10) Pub. No.: US 2013/0163101 A1
(43) Pub. Date: Jun. 27, 2013

(54) IMAGE CAPTURING LENS AND IMAGE CAPTURING DEVICE

(71) Applicants: Yasunari Fukuta, Osaka-shi (JP); Kazuki Matsui, Higashiyamato-shi (JP); Ryouta Ishikawa, Hachioji-shi (JP); Takashi Kawasaki, Koganei-shi (JP)

(72) Inventors: Yasunari Fukuta, Osaka-shi (JP); Kazuki Matsui, Higashiyamato-shi (JP); Ryouta Ishikawa, Hachioji-shi (JP); Takashi Kawasaki, Koganei-shi (JP)

(21) Appl. No.: 13/821,532

(22) PCT Filed: Sep. 5, 2011
(86) PCT No.: PCT/JP2011/070139

§ 371 Date: Mar. 7, 2013

(30) Foreign Application Priority Data
Sep. 9, 2010 (JP) 2010-201771

(51) Int. Cl. G02B 9/08

(52) U.S. Cl. CPC G02B 9/08
USPC 359/794

(57) ABSTRACT

An image capturing lens is disclosed, which is compact and capable of capturing an image at a wide angle though realizing low cost performance by enabling mass productions of wafer-scale lenses, and an image capturing device is disclosed, which uses this image capturing lens. For the purpose of attaining short focusing, a wide angle of view can be ensured by optimally disposing the power of a first lens block and the power of a second lens block so that a value of a conditional formula (1) becomes higher than a lower limit. Hereat, a wider angle can be attained by strengthening the positive power of the second lens block against the first lens block without increasing the overall length. While on the other hand, the value of the conditional formula (1) becomes lower than an upper limit, whereby the power of the second lens block is prevented from being excessively strengthened, the lens units of the second lens block can be configured with a small sag quantity, and moldability can be kept preferable,

0.9<f1/f2<2.5 (1)

where,
f1: the synthesized focal length of the first lens block, and
f2: the synthesized focal length of the second lens block.

### TECHNICAL FIELD

The present invention relates generally to an image capturing lens, and more particularly to a small-sized and thin image capturing lens suited to being mounted on a mobile terminal etc. such as a notebook PC.

### BACKGROUND ART

Small-sized and thin image capturing devices have got mounted on the mobile terminals classified as the compact and thin electronic devices such as a PDA (Personal Digital Assistant), thereby enabling image information as well as voice information to be mutually transmitted to remote places.

An image capturing element used for these image capturing devices involves using a solid-state image capturing element such as a COD (Charge Coupled Device) image sensor and a CMOS (Complementary Metal-Oxide Semiconductor) image sensor. In recent years, micronization of pixel pitches (values on micro order) of the image capturing lens LN has been advanced, and a higher resolution and higher performance have been attained, by increasing the number of pixels. On the other hand, downsizing of the image capturing element is also attained while keeping the pixels as the case may be. In addition, recently the number of mobile terminals each having a so-called. TV phone function is on the verge of increasing, in which images of users, who use the mobile terminals, are captured and transmitted to conversation partners, and the images of the conversation partners are mutually displayed.

By the way, the lenses for forming an image of a subject on each of these image capturing elements have come to use lenses composed of resins suited to mass production in order to decrease further costs. Moreover, the lens composed of the resin has met a request for enhancing the performance. Much higher functions are, however, demanded of the lenses.

On the other hand, an optical system taking a lens element configuration including 2 through 4 plastic and glass lenses, is generally well known as an image capturing lens used for an image capturing device built in the mobile terminal. It is, however, difficult to establish compatibility between further compactness of these optical systems and the mass productivity demanded of the mobile terminal.

In this connection, such a technique is proposed for establishing the compatibility between the compactness and the mass productivity that the lens elements are simultaneously molded in massive quantities on wafers, i.e., parallel-plane plates, having a size of several inches by a replica technique, these wafers are, after being combined with sensor wafers, separated, and lens modules are produced in the massive quantities. The lenses manufactured by the manufacturing method such as this are called wafer scale lenses, and the lens modules are called wafer scale lens modules.

Moreover, along with the technique of mass-producing the lens modules, over the recent years there has been proposed a technique of simultaneously packaging electronic components and the lens modules on a substrate by executing a reflow process (heating treatment) on the substrate undergoing solder potting beforehand while being mounted with the lens module together with an IC (Integrated Circuit) chip and other electronic components and by melting the solder as a method of packaging the lens modules on the substrate in the massive quantities at low costs, and an image capturing lens being excellent of heat resistance endurable against the reflow process has been also requested

Patent documents 1-1 are proposed, in which the image capturing lens includes lens blocks each taking a lens element configuration of 2 lens elements.

### DOCUMENTS OF PRIOR ARTS

### Patent Documents

[Patent document 1] Specification of U.S. Pat. No. 3,929,479
[Patent document 2] Specification of U.S. Pat. No. 3,976,781
[Patent document 3] Specification of U.S. Pat. No. 7,457,053
[Patent document 4] Specification of U.S. Pat. No. 7,474,480

### SUMMARY OF THE INVENTION

### Problems to be Solved by the Invention

For example, performance of a wide angle is requested of the image capturing lens used when capturing an image of a user at a near distance, who employs the mobile terminal, in order to exhibit the TV phone function described above. In the case of the image capturing lenses of Patent documents 1-4, however, a problem is that these lenses have none of the required performance of the wide angle. Further, if the performance of the wide angle is given to the image capturing lenses of Patent documents 1-4, thickness the lens unit must be increased, resulting in a problem that moldability declines and a length of the image capturing lens becomes elongate. Especially, the increase in thickness of the lens unit leads to outstanding decreases in surface accuracy and in correspondence-to-reflow performance and therefore becomes an important factor in terms of raising an image quality.

It is an object of the present invention, which was devised in view of these problems, to provide a compact image capturing lens enabled to be mass-produced as a wafer scale lens to realize low costs and being capable of capturing an image at a wide angle and to provide an image capturing device using this image capturing lens.

### Means for Solving the Problems

An image capturing lens of claim 1, when a lens block is defined as an optical element including a lens substrate serving as a parallel-plane plate and a lens unit formed on at least one of an object-side surface and an image-side surface of the lens substrate and having positive or negative power, materials of the lens unit and the lens substrate are different from each other, sequentially from an object side, includes:

a first lens block having the positive power; and

a second lens block having the positive power,

wherein an aperture stop is provided on the object side of the first lens block or in an interior or the first lens block,

focal lengths of the first lens block and of the second lens block satisfy the following conditional formula (1), and

a surface, closest to the image side, the second lens block is an aspherical surface being paraxial, taking a shape with a convex surface directed toward the image side and having at least one inflection point,

0.9<f1/f2<2.5 (1)

where,
f1: a focal length of the first lens block, and
f2: a focal length of the second lens block.

For the purpose of attaining short focusing, a wide angle of view can be ensured by optimally disposing the power of the first lens block and the power of the second lens block so that the vaue of the conditional formula (1) becomes higher than a lower limit. Hereat, a wider angle can be attained by strengthening the positive power of the second lens block against the first lens block without increasing the overall length. While on the other hand, the value of the conditional formula (1) becomes lower than an upper limit, whereby the power of the second lens block is prevented from being excessively strengthened, the lens units of the second lens block can be configured with a small sag quantity (which is a distance in an optical-axis direction from a surface apex of an optical surface in a heightwise position in a certain direction orthogonal to the optical axis), and moldability can be kept preferable. Note that the preferable sag quantity ranges from 0.0 mm to 0.35 mm.

Herein, if the aperture stop is disposed in the vicinity of the second lens block, an effective diameter of the lens unit can be restrained, and the strong positive power can be added thereto while restraining the thickness of the lens unit. If the aperture stop is disposed in the vicinity of the second lens block, however, a position of an exit pupil inevitably gets close to the image side, and consequently there is also some fear that a telecentric property declines. Such being the case, in the present invention, the aperture stop is disposed in the vicinity of the first lens block so as to be on the object side of the first lens block or in an interior of the first lens block, while the thickness of the second lens block is reduced, and the surface, having the largest effective diameter and being closest, to the image side, of the second lens block takes a configuration of an aspherical surface having at least one inflection point in order to reduce the thickness of the second lens block. This configuration enables the sag quantity to be decreased and the moldability to be enhanced. Furthermore, a lens back is elongated by giving a paraxial concave surface on the image side, the effective diameter of the lens unit of the second lens block can be restrained by its being distanced farther from the image capturing element, whereby the thickness of the lens unit can be reduced. It is desirable in terms of taking the moldability and molding time into consideration that the thickness of the lens unit in the optical-axis direction is herein equal to or larger than 0.05 mm but equal to or smaller than 0.40 mm. Note that the phrase “being disposed in the vicinity of the first lens block” implies that it may be formed not only in front and in rear of the first lens block but also within the first lens block, e.g., on the lens substrate. Further, the phrase “having the inflection point” implies that the section of the optical surface in the optical-axis direction has such a point the sign of a gradient of a tangential line of the optical surface changes from negative to positive and vice versa when setting 0 degree in the direction orthogonal to the optical axis.

Moreover, it is desirable that the surface, closest to the image side, of the second lens block satisfies the following conditional formula (2),

0.1<f/r22<1.2 (2)

where,
f: a synthesized focal length of the whole image capturing lens system, and
r22: a paraxial radius of curvature of the surface, closest to the image side, of the second lens block.

If a value of the conditional formula (2) is larger than a lower limit, a curvature of field can be reduced, and, whereas if the value of the conditional formula is lower than an upper limit, the telecentric property can be enhanced without excessively sharply raising the light beam.

The image capturing lens of claim 2, in the invention according to claim 1, is characterized in that an air space between The first lens block and the second lens block satisfies the following conditional formula (3),

0.03<D4/f<0.15 (3)

where,
D4: an on-optical-axis air space between the first lens block and the second lens block, and
f: a synthesized focal length of the whole image capturing lens system.

If a value of the conditional formula (3) is larger than the lower limit, the lenses can be prevented from being damaged due to abutment between the lenses when assembled. Whereas if the value of the conditional formula (3) is smaller than the upper limit, an overall length of the image capturing lens can be prevented from increasing excessively.

The image capturing lens of claim 3, in the invention according to claim 1 or 2, is characterized in that a paraxial radius of curvature of an optical surface of the first lens block satisfies the following conditional formula (4),

0.3r11/r12<1.0 (4)

where,
r11: a paraxial radius of curvature of a surface, closest to the object side, of the first lens block, and
r12: a paraxial radius of curvature, closest to the image side, of the first lens block.

If a value of the conditional formula (4) is larger than the lower limit, the curvature of field can be preferably corrected, and, whereas if the value of the conditional formula (4) is smaller than the upper limit, it is feasible to decrease influence on image capturing performance, which is exerted by an error when manufactured, without any excessively strong curvature.

The image capturing lens of claim 4, in the invention according to any one of claims 1 to 3, is characterized in that the paraxial radius of curvature of a surface, closest to the object side, of the second lens block satisfies the following conditional formula (5),

0.45<r21/f<0.65 (5)

where,
r21: a paraxial radius of curvature of a surface, closest to the object side, of the second lens block, and
f: the synthesized focal length of the whole image capturing lens system.

If a value of the conditional formula (5) is larger than the lower limit, the sag quantity can be reduced without any excessively strong curvature. Whereas if the value of the conditional formula (5) is smaller than the upper limit, the curvature of field can be prevented from excessively increasing.

The image capturing lens of claim 5, in the invention according to any one of claims 1 to 4, is characterized in that the object-side surfaces of the second lens block have the same sign with respect to gradients of tangential lines of shapes of the lens surfaces in regions within effective diameters exclusive of the centers of the lenses.

Such a shape as to change the sign of the gradient of the surface, i.e., an inflection point, is not given to the object-side surface of the second lens block, whereby deterioration of the image quality can be reduced without a large change in image forming position even when the second lens block deviates from the optical axis substantially in the vertical direction.

The image capturing lens of claim 6, in the invention according to any one of claims 1 to 5, is characterized in that the image capturing lens is used for forming an image of light of a subject on the image capturing surface of the image capturing element, and satisfies the following conditional formula (6),

ωD≧65° (6)

where,
ωD: an overall angle of view, at an opposite angle, of the image capturing element.

It is feasible to simultaneously capture an image of a background and an image of a photographer by giving a wide view angle satisfying the conditional formula (6) when capturing the image of the photographer himself or herself who holds an image capturing device mounted with the image capturing lens such as this with his or her hand. It is desirable to satisfy the following conditional formula (6′). If the view angle is as wide as satisfying the conditional formula (6′), it is possible to simultaneously capture the image of the background, the image of the photographer and an image of a person standing next to the photographer when capturing the image of the photographer himself or herself who holds the image capturing device mounted with the image capturing lens such as this with his or her hand, and an added value is further enhanced,

ωD≧70° (6′)

The image capturing lens of claim 7, in the invention according to any one of claims 1 to 6, is characterized in that the aperture stop is disposed on the lens substrate of the first lens block.

The aperture stop is disposed on the lens substrate of the first lens block, whereby it follows that the aperture stop is disposed between the lend unit of the first lens block and the lens substrate portion. This arrangement enables the optical effective diameter to be decreased, the thickness of the lens unit to be reduced and the aperture stop to be formed by executing a vapor deposition process simultaneously when performing the vapor deposition process for an IR (InfraRed) cut coat over the lens substrate portion and for an AR (Anti-Reflection) coat for avoiding occurrence of unnecessary light due to reflection from an interface if there is a large difference between a refractive index of the lens unit and a refractive index of the lens substrate, whereby low cost performance and mass productivity can be improved. Further, the aperture stop is disposed within the lens substrate, whereby a principal light beam passes through the lens surface closest to the object side so as to be concentric, a deflection angle to the surface decreases, and deterioration of performance with respect to eccentricity can be reduced. Note that the aperture stop is, it is desirable, disposed on the lens substrate on the object side of the first lens block. The position of the exit pupil can be distanced from the image capturing element by its being disposed in the position closest to the object side within the image capturing lens, and the telecentric property can be improved.

The image capturing lens of claim 8, in the invention according to any one of claims 1 to 7, is characterized in that the image capturing lens involves using at least two types of resin materials.

The use of resins composed of materials having different Abbe's numbers and different refractive indices enables a degree of freedom of a design to be increased and the performance to be improved. Further, a change in image forming position can be decreased by setting the arrangement of the optimal materials even when a temperature changes.

The image capturing lens of claim 9, in the invention according to claim 8, is characterized in that inorganic particles, of which a particle size is equal to or smaller than 30 nanometers, are dispersed in at least one type of resin material.

The inorganic particles, of which the particle size is equal to or smaller than 30 nanometers, are dispersed in the lens unit composed of the resin material, whereby it is feasible to decrease both of the deterioration of the performance even when the temperatre changes and a fluctuation in position of an image point, and, besides, the image capturing lens having the excellent optical characteristics can be provided irrespective of environmental changes without decreasing transmittance of the light. Generally, when the particles are mixed in the transparent resin material, the light is scattered with the result that the transmittance decreases, and it is therefore difficult to use the particles-mixed resin material as the optical material; however, the scattered light can be prevented from substantially occurring by setting the particle size smaller than a wavelength of a flux of transmitted light.

Furthermore, the resin material has a defect that the refractive index thereof is lower than that of a glass material, however, it is recognized that the refractive index can be increased if the inorganic particles exhibiting the high refractive index are dispersed in the resin material serving as a base material. To be specific, a material having arbitrary temperature dependency can be provided by dispersing the inorganic particles, of which the particle size is equal to or smaller than 30 nanometers, into a plastic material serving as the base material, more desirably dispersing the inorganic particles, of which the particle size is equal to or smaller than 20 nanometers, into the resin material serving as the base material and much more desirably dispersing the inorganic particles, of which the particle size is equal to or smaller than 15 nanometers, thereinto.

Moreover, it is also known that the refractive index of the resin material comes to decrease as the temperature rises, however, if the inorganic, particles with the refractive index increasing when the temperature rises are dispersed into the resin material, serving as the base material, the substances act so as to cancel these properties, and hence a change in refractive index against the change in temperature can be decreased. Further, it is also known that conversely when dispersing the inorganic particles with the refractive index decreasing as the temperature rises into the resin material serving as the base material, the change in refractive index against the change in temperature can be augmented. Specifically, the material having the arbitrary temperature dependency can be provided by dispersing the inorganic particles, of which the particle size is equal to or smaller than 30 nanometers, into the plastic material serving as the base material, more desirably dispersing the inorganic particles, of which the particle size is equal to or smaller than 20 nanometers, into the resin material serving as the base material and much more desirably dispersing the inorganic particles, of which the particle size is equal to or smaller than 15 nanometers, thereinto.

For example, the plastic material exhibiting the high refractive index is obtained by dispersing the particles of aluminum oxide (Al₂O₃) or lithium niobate (LiNbO₃) into an acrylic resin, and the change in refractive index against the temperature can be reduced.

Next, an in-depth description of a temperature change A of the refractive index will be made. The temperature change A of the refractive index is expressed based on the Lorentz-Lorenz formula in a way that differentiates a refractive index n with a temperature t in the following formula.

$$A = \frac{( {n}^{2} + 2 ) ( {n}^{2} - 1 )}{6 n} \{ ( - 3 α ) + \frac{1}{[ R ]} \frac{\partial [ R ]}{\partial t} \} \qquad [ Mathematical Expression 1 ]$$

where, α represents a coefficient of linear expansion, and [R] denotes molecular refraction.

In the case of the resin material, generally a contribution of the second term is smaller than the first term in the formula and can be therefore substantially ignored. For example, in the case of a PMMA resin, the linear expansion coefficient α is given such as 7×10⁻⁵, and, when substituted into the formula given above, the result is given by dn/dt=−1.2×10⁻⁴ [/° C.], in which a value is substantially coincident with an actually measured value.

Herein, the contribution of the second term of the formula given above is substantially augmented by dispersing the particles, desirably the inorganic particles into the resin material, thus canceling the change due to the linear expansion in the first term. To be specific, it is desirable that the change, which has hitherto been approximately −1.2×10⁻⁴, is restrained down to 8×10⁻⁵ or less by way of an absolute value.

Moreover, a temperature characteristic opposite to that of the resin material as the base material can be given by further augmenting the contribution of the second term. Namely, it is also possible to acquire a material with its refractive index not decreasing but conversely increasing due to the rise in temperature.

A mixing rate can be incremented or decremented properly for controlling a rate of the change in refractive index against the temperature, and plural types of inorganic particle, of which the particle size is on the nano scale, are blended and can be thus dispersed.

An image capturing device of claim 10 is characterized by including the image capturing lens according to any one of claims 1-9, and hence it is feasible to provide the image capturing device capable of capturing the image at the wide angle while having the high image capturing performance at the low costs.

### Effects of the Invention

According to the present invention, it is possible to provide the compact image capturing lens enabled to be mass-produced as the wafer scale lens to realize the low costs and being capable of capturing the image at the wide angle and to provide an image capturing device using this image capturing lens.

### BRIEF DESCRIPTION OF THE DRAWINGS

FIG. 1 is a perspective view of an image capturing device LU according to the present embodiment.

FIG. 2 is a sectional view, taken along the arrowed lines II-II, of a configuration in FIG. 1 as viewed in an arrowed direction.

FIG. 3 is a view illustrating a mobile phone T.

FIG. 4 is a diagram illustrating a manufacturing step of an image capturing lens LN.

FIG. 5 is a sectional view of the image capturing lens according to a first working example.

FIG. 6 is an aberration diagram of a spherical aberration (a), an astigmatism (b) and a distortion (c) of the image capturing lens according to the first working example.

FIG. 7 is a sectional view of the image capturing lens according to a second working example.

FIG. 8 is an aberration diagram of the spherical aberration (a), the astigmatism (b) and the distortion (c) of the image capturing lens according to the second working example.

FIG. 9 is a sectional view of the image capturing lens according to a third working example.

FIG. 10 is an aberration diagram of the spherical aberration (a), the astigmatism (b) and the distortion (c) of the image capturing lens according to the third working example.

FIG. 11 is a sectional view of the image capturing lens according to a fourth working example.

FIG. 12 is an aberration diagram of the spherical aberration (a), the astigmatism (b) and the distortion (c) of the image capturing lens according to the fourth working example.

FIG. 13 is a sectional view of the image capturing lens according to a fifth working example.

FIG. 14 is an aberration diagram or the spherical aberration (a), the astigmatism (b) and the distortion (c) of the image capturing lens according to the fifth working example,

FIG. 15 is a sectional view of the image capturing lens according to a sixth working example.

FIG. 16 is an aberration diagram of the spherical aberration (a), the astigmatism (b) and the distortion (c) of the image capturing lens according to the sixth working example.

FIG. 17 is a sectional view of the image capturing lens according to a seventh working example.

FIG. 18 is an aberration diagram of the spherical aberration (a), the astigmatism (b) and the distortion (c) of the image capturing lens according to the seventh working example.

FIG. 19 is a sectional view of an image capturing device LU according to another embodiment.

### BEST MODE FOR CARRYING OUT THE INVENTION

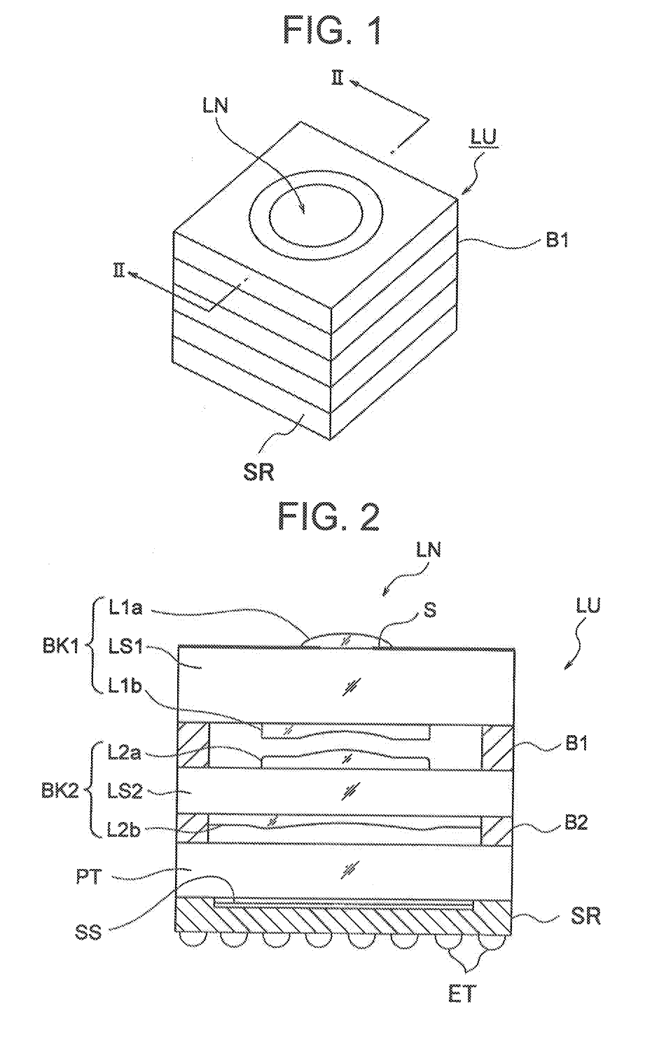

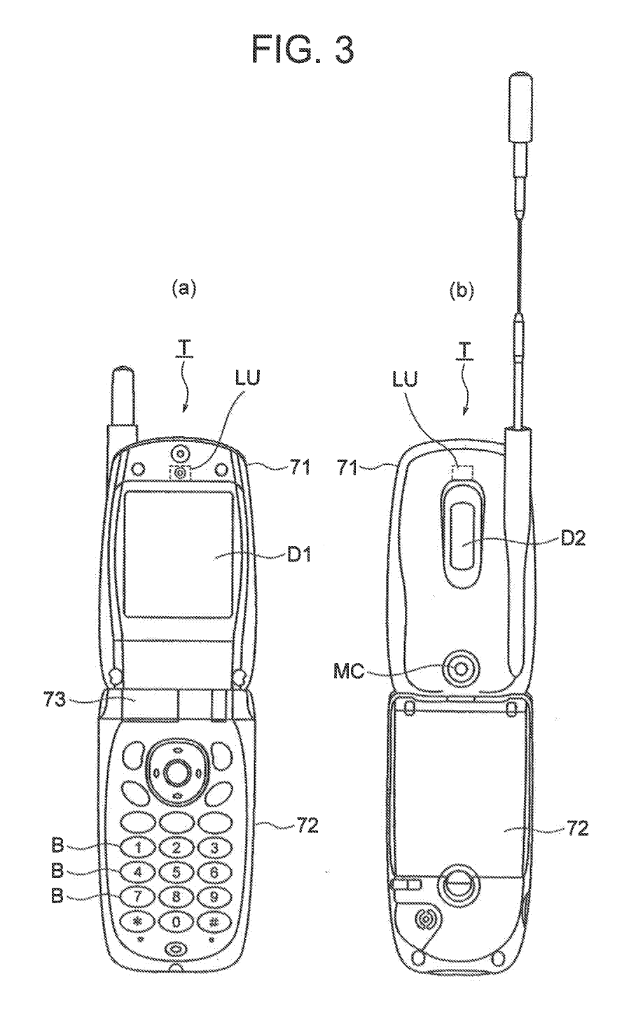

Embodiments of the present invention will hereinafter be described based on the drawings. FIG. 1 is a perspective view of an image capturing device LU according to the embodiment, and FIG. 2 is a sectional view, taken along the arrowed line II-II, of a configuration of FIG. 1 as viewed in an arrowed direction. As illustrated in FIG. 2, the image capturing device LU includes a CMOS (Complementary Metal Oxide Semiconductor) image sensor SR classified as a solid-state image sensing device having a photoelectric converting unit SS, an image capturing lens LU through which the photoelectric converting unit SS (a light receiving surface) of the image sensor 52 captures an image of a subject, and an external connection terminal (electrode) ET which transmits and receives electric signals thereof, in which these components are integrally built up. Note that the image capturing lens LN includes, sequentially from an object side (from upward in FIG. 2), a first lens block BK1 and a second lens block BK2. Then, the lens blocks BK1, BK2 are assembled by, e.g., joining lens units to two surfaces (a substrate surface on the object side and a substrate surface on an image side) having a face-to-face relation with each other via a lens substrate LS (note that this lens unit has positive or negative power). It is to be noted that the term “joining” implies that the substrate surface of the lens substrate and the lenses are in a direct bonding state or that the substrate surface of the lens substrate and the lenses are in an indirect bonding state via another different member.

The image sensor SR includes the photoelectric converting unit SS configured as the light receiving unit by two-dimensionally arraying pixels (photoelectric converting elements) on a central portion of a flat surface on the light receiving side thereof, and is connected to an unillustrated signal processing circuit. Such a signal processing circuit is configured to include drive circuit units which acquire signal charges by sequentially driving the respective pixels, A/D converting units which convert the respective signal charges into digital signals, and signal processing units which generate image signal outputs by use these digital signals. Further, a multiplicity of pads (an illustration thereof is omitted) is disposed in the vicinity of an outer edge of the flat surface on the light receiving side of the image sensor SR and is connected to the image sensor SR via unillustrated wires. The image sensor SR converts the signal charges given from the photoelectric converting units SS into image signals etc. such as digital YUV signals, and outputs the image signals to predetermined circuits is wires (unillustrated). Herein, “Y” stands for a luminance signal, “U” (=R−Y) represents a color difference signal between red and the luminance signal, and “V” (=B−Y) denotes a color difference signal between blue and the luminance signal. Note that the solid-state image capturing element is not limited to the CMOS image sensor described above but may involve using other types of image sensors such as the CCD image sensor.

The image sensor SR is connected to an external circuit (e.g., a control circuit included by a host device of a mobile terminal mounted with the image capturing device) via the external connection terminal ET, thereby making it possible to be supplied with a voltage for driving the image sensor SR and clock signals from the external circuit and to output the digital YUV signals to the external circuit.

An upper portion of the image sensor SR is sealed by a plate PT such as a seal glass. A lower edge of a spacer member B2 is fixed to the upper surface of the plate PT. Further, a second lens block BK2 is fixed to an upper edge of the spacer member B2, a lower edge of another spacer member B1 is fixed to an upper surface of the second lens block BK2, and a first lens block SK1 is fixed to an upper edge of the spacer member B1. Herein, the spacer member is disposed on the lens substrate but may also be disposed outside an effective diameter of the lens unit. Note that the function of the spacer member may also be given by exploiting a region outside an optical effective area of the lens unit without using the spacer member.

The first lens block BK1 is configured to include a first parallel-plane lens substrate LS1 made of glass, and resinous lens units L1a, L1b fixed to the object side and the image surface side, while the second lens block BK2 is configured to include a second parallel-plane lens substrate LS1 made of glass, and resinous lens units L2a, L2b fixed to the object side and the image surface side. The first lens block BK1 and the lens units L1a, L1b are different in terms of at least one of their refractive indices and Abbe's numbers, and, i.e., the second lens block BK2 and the lens units L2a, L2b are different in terms of at least one of their refractive indices and Abbe's numbers. At least one of the lens units L1a, L1b, L2a, L2b may be composed of a different resinous material. Further, the parallel-plane lens substrate may involve using a resinous material different from those of the lens members.

The first lens block BK1 has the positive power. The first object-side lens unit L1a formed on the object-side surface of the first lens substrate LS1 has its object-side surface taking a shape of a convex surface on the object side. Further, the first image-side lens unit L1b formed on the image-side surface of the first lens substrate LS1 has its image
side surface taking a shape of a concave surface on the image side. Note that a light shielding film is formed on the object-side surface of the first lens substrate LS1, and a circular aperture through which the light can be transmitted is formed in the center of this light shielding film, whereby this aperture may serve as an aperture stop S but is not limited the aperture stop.

The second lens block BK2 has the positive power. The second object-side lens unit L2a formed on the object-side surface of the second lens substrate LS2 has its object-side surface taking the shape of the convex surface on the object side. Further, the second image-side lens unit L2b formed on the image-side surface of the second lens substrate LS2 includes its image-side surface being paraxial, taking the shape of the concave surface on the image side and having one inflection point.

The image capturing lens LN satisfies the following formula.

0.9<f1/f2<2.5 (1)

where
f1: a synthesized focal length of the first lens block BK1, and
f2: a synthesized focal length of the second lens block BK2.

Incidentally, it is preferable that at least one of the lens units L1a-L2b is composed of a UV hardening resinous material in which to disperse inorganic particulates with their particle size being equal to or smaller than 30 nanometers at the maximum,

Next, a mobile phone will next be described based on FIG. 3 showing a view of an external appearance thereof by way of one example of the mobile terminal equipped with the image capturing device. Note that FIG. 3(a) is a view of the mobile phone as viewed from inside by opening the folded mobile phone, and FIG. 3(b) is a view as viewed from outside by opening the folded mobile phone.

In FIG. 3, a mobile phone T is configured by joining an upper housing 71 serving as a case including display screens D1, D2 to a lower housing 72 including operation buttons B via a hinge 73. In the present embodiment, a main image capturing device MC for capturing images of landscapes etc. is provided, on the surface side of the upper housing 71, and the image capturing device LU equipped with the wide-angled image capturing lens LN described above is provided on the display screen D1 on the side of the rear surface (internal surface) of the upper housing 71.

The image capturing lens LN has an angle of view with its overall angle-of-view ωD at a diagonal angle of the image capturing element being as wide as 65° or larger, and hence, as illustrated in FIG. 3(a), the image capturing device LU can capture an image of the upper half part of a user himself or herself who holds the mobile phone T with a hand in a face-to-face status with the image capturing device LU. An image signal thereof is transmitted to a mobile phone of a communication partner, the user's image of the transmitter user to can be thus displayed, and a normal phone call is conducted, thereby enabling a so-called TV telephone to be realized. Note that the mobile phone T is not limited to the folding type of phone.

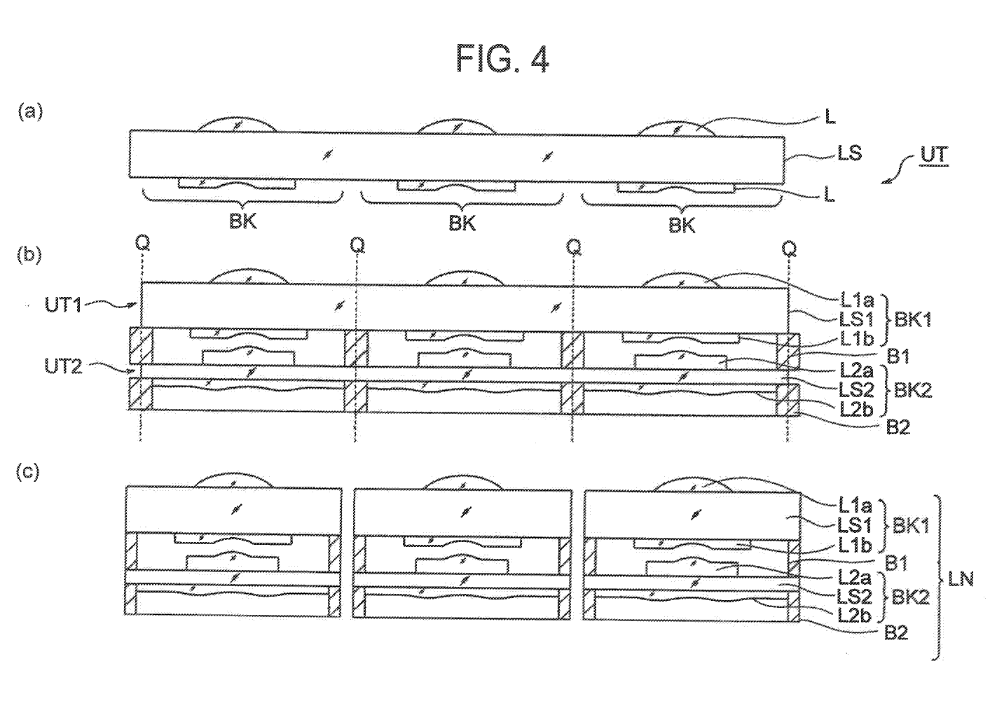

A method of manufacturing the image capturing lens LN will hereinafter be described. As depicted in a sectional view of FIG. 4(a), a lens block unit UT including a plurality of aligned lens blocks BK is manufactured by a replica technique capable of manufacturing a multiplicity of lenses simultaneously at a low cost (note that the number of the lens block(s) BK included in the lens block unit UT may be either singular or plural). It is to be noted that the aperture stop can be produced at one time by forming a light shielding film including a plurality of apertures on the lens substrate before configuring the lens unit by the replica technique.

The replica technique involves shaping the hardening resinous material in a lens shape by use of a metal mold and transferring the lens-shaped resinous material onto the glass substrate. In this replica technique, the multiplicity of lenses is thereby manufactured simultaneously on the glass substrate.

Then, the image capturing lens LN is manufactured from the lens block unit UT manufactured by these techniques. A schematic sectional view of FIG. 4(b) illustrates one example of a step of manufacturing this image capturing lens.

A first lens block unit UT1 is configured by assembling the first lens substrate LS1 defined as the parallel-plane plate, the first object-side lens L1a bonded to one flat surface thereof, and a first image-side lens L1b bonded to the other flat surface thereof.

The second lens block unit UT2 is configured by assembling the second lens substrate LS1 defined as the parallel-plane plate, the second object-side lens L2a bonded to one flat surface thereof, and a second image-side lens L2b bonded to the other flat surface thereof. Note that at least the second image-side lens L2b is provided with the inflection point, thereby enabling lens moidability to be enhanced while restraining the thickness thereof.

The lattice-like spacer member (spacer) B1 is interposed between the first lens block unit. UT1 and the second lens block unit UT2 (to be specific, between the first lens substrate LS1 and the second lens substrate LS2) to keep constant an interval between the two lens block units UT1 and UT2. Further, the spacer member 32 is interposed between the parallel-plane plate PT and the second lens block unit UT2 to keep constant an interval between the parallel-plane plate PT and the second lens block unit UT2 (i.e., the spacer members 31, 32 can be said to be a two-stage lattice). Then, the respective lenses L1a-2b are positioned in holes of the lattice of the spacer members 31, 32.

Note that the parallel-plane plate PT is a parallel-plane plate (corresponding to the parallel-plane plate PT in FIG. 2) such as a wafer-level sensor chip size package including a micro lens array or a sensor cover glass or an IR cut filter.

Then, the spacer member B1 is interposed between the first lens block unit UT1 and the first lens block unit UT2, whereby the lens substrates LS (the first lens substrate LS1 and the second lens substrate LS2) are sealed and thus integrated together.

Then, the first lens substrate LS1, the second lens substrate LS2 and the spacer members B1, B2, which are thus integrated together, are cut off along lattice frames (in positions of broken lines Q), at which time, as depicted in FIG. 4(c), a plurality of image capturing lenses LN each having a 2-element lens configuration is acquired.

Thus, the members built in the plurality of lens blocks (the first lens block BK1 and the second lens block BK2) are cut apart, and the image capturing lens LN is thereby manufactured, in which there are eliminated necessities for adjusting the lens-to-lens interval and assembling the lenses for every image capturing lens LN. Therefore, a mass production of the image capturing lenses LN can be attained.

Based on what has been discussed so far, the manufacturing method of the image capturing lens LN includes a joining step of arranging the spacer members B1 in at least portions of the circumferences of the lens blocks BK1, BK2 and joining the plurality of lens block units UT1, UT2 in a way that interposes the spacer members B1 therebetween, and a cutting step of cutting off the joined lens block units UT1, UT2 along the spacer members B1. Then, this type of manufacturing method is suited to the mass-production of the image capturing lenses at the low cost.

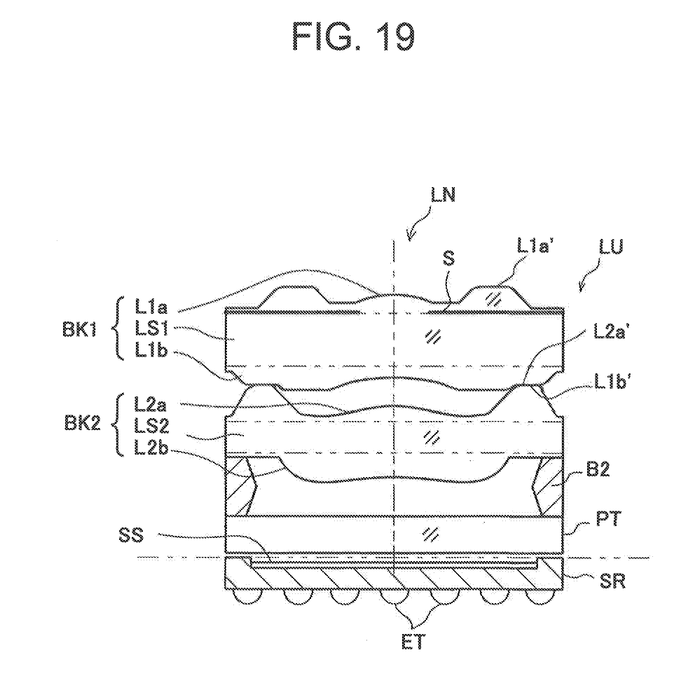

The description of the case, in which the spacer member is interposed between the lens blocks, is made so far, however, there will be described the lens block unit given the function as the spacer member by exploiting the region outside the optical effective surface of the lens unit without using the spacer member. FIG. 19 is a sectional view, similar to FIG. 2, of the image capturing device according to another embodiment. As illustrated in FIG. 19, the image capturing device LU includes the CMOS image sensor SR as the solid-state image capturing element having the photoelectric converting unit SS, the image capturing lens LN which captures an image of the subject on the photoelectric converting unit (light receiving surface) SS of this image sensor SR, and the external connection terminal (electrode) ET which transmits and receives the electric signals, these components being integrally built up. Note that the image capturing lens LN includes, sequentially from the object side (an upper side in FIG. 19), the first lens block BK1 and the second lens block BK2. The upper portion of the image sensor SR is sealed by a plate PT such as a seal glass. A lower edge of the spacer member 52 is fixed to an upper surface of the plate PT. The first lens block BK1 and the second lens block BK2 are formed by the same manufacturing method as in the embodiment discussed above, and the descriptions of the common components are omitted. A flange portion of the second object-side lens L2a has protruded portions L2a′ protruded on the object side in the way of taking an orbicular zone shape or being equally disposed around the optical axis, and these protruded portions L2a′ abut on image-side flange surfaces L1b′ of the first image-side lens L1b. That is, the second lens block BK2 is fixed to the upper edge of the spacer member B2, while the first lens block BK1 is fixed directly to the upper surface of the second lens block BK2. The first lens block BK1 and the second lens block BK2 are fixed with no intermediary of the spacer member, thereby enabling the accuracy of the interval, between the lens blocks to be enhanced. Further, the flange portion of the first object-side lens L1a has protruded portions L1a′ protruded on the object side in the way of taking the orbicular zone shape or being equally disposed around the optical axis.

### First Working Example

Next, a working example preferable to the embodiment discussed above will hereinafter be described. The following working example does not, however, limit the present invention. Notations of respective reference symbols in the working example are given as follows.

f: a focal length of the whole system of an image capturing lens,
fB: a back focus,

### F: an F-number,

2Y: a length of a diagonal line of the image capturing surface of the solid-state image capturing element (the length of the diagonal line of a rectangular effective pixel area of the solid-state image capturing element),
ENTP: a position of an entrance pupil (a distance from the first surface up to the entrance pupil),
EXTP: a position of an exit pupil (a distance from an image surface up to the exit pupil),
H1: a position of a front-side principal point (a distance from the first surface up to the front-side principal point),
H2: a position of a rear-side principal point (a distance from the last surface up to the rear-side principal point,
r: a radius of curvature of a refracting surface,
d: an on-axis surface interval,
nd: a refractive index of the d-line of a lens material at the normal temperature,
vd: an Abbe's number of the lens material, and
STO: an aperture stop.

In each working example, the surface marked with “*” suffixed to each surface number is a surface including a shape of aspherical surface that is expressed by the following [Mathematical Expression 2] in which the apex of the surface serves as the origin, the X-axis is taken alone the optical-axis direction, and h represents the height in the direction perpendicular to the optical axis.

$$X = \frac{{h}^{2} / R}{1 + \sqrt{1 - ( 1 + K ) {h}^{2} / {R}^{2}}} + \sum {A}_{i} {h}^{i} \qquad [ Mathematical Expression 2 ]$$

where,
Ai: an i-th order aspherical surface coefficient,
R: a reference radius of curvature, and
K: a constant of cone.

It should be noted that a semantic implication of the paraxial radius of curvature described in the appended claims and the working examples is such that an approximate radius of curvature given when fitting a shape measurement value in the vicinity of the center of the lens (which is specifically a 10% or smaller central region of the area defined by the outside diameter of the lens) on the basis of the least-square method can be deemed to be the paraxial radius of curvature in the situation of the actual lens measurement.

Further, for instance, in the case of using a secondary aspherical surface coefficient, the radius of curvature taking the secondary aspherical surface coefficient into consideration for the reference radius of curvature in the definitional equation of the aspherical surface, can be deemed to be the paraxial radius of curvature (refer to, e.g., pp. 41-42 of “Lens Design. Method” (published by Kvoritsu Shuppan Co., Ltd.) authored by Yoshiya Matsui).

Furthermore, in what will hereinafter be given (including the lens data in the Tables), an exponential number of 10 (e.g., 2.5×10⁻⁰²) is to be expressed by using the N notation (e.g., 2.5E-02) or e notation. Moreover, the surface numbers of the lens data are allocated to the lens surfaces in sequence in the way of setting an object-side surface of the first lens as a first surface. Note that the unit of numerical values representing the lengths described in the working examples throughout is “mm”.

### First Working Example

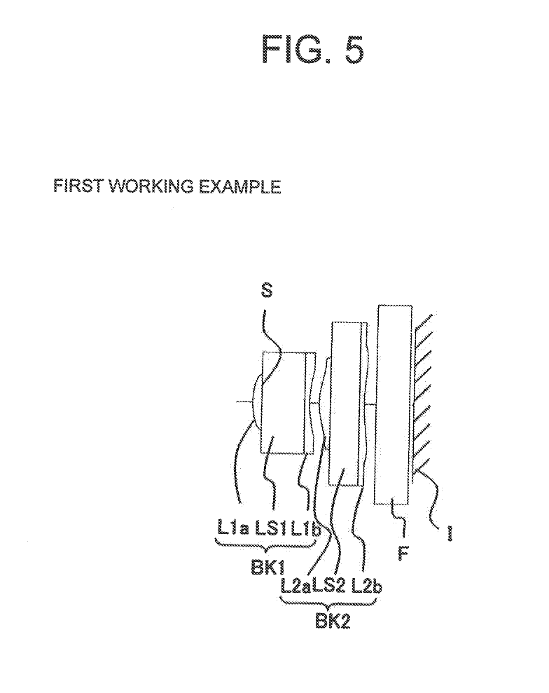

Table 1 shows the lens data in a first working example. FIG. 5 is a sectional view of the lenses in the first working example. A first lens block BK1 having positive power is configured to include, sequentially from the object side, a first object-side, lens unit L1a convexed toward the object side, an aperture stop S, a first lens substrate LS1 having a function as an IR cut filter and a first image-side lens unit L1b concaved toward the image side; next a second lens block BK2 having the positive power is configured to include a second object-side lens unit L2a convexed toward the object side, a second lens substrate LS2 and a second image-side paraxial lens unit L2b convexed toward the image side; and finally the parallel-plane plate PT assumed to use the seal glass etc. of the solid-state image capturing element is provided. Herein, the IR cut filter serves also as the first lens substrate LS1, however, the parallel-plane plate PT may be used as the IR cut filter, and further the IR cut filter may be added as another member of the parallel-plane plate. The symbol “I” denotes an image capturing surface of the image capturing element. Only the second image-side lens unit L2b has the inflection point.

TABLE 1
FIRST WORKING EXAMPLE
SURF DATA

| | | | | | EFFECTIVE |
|---|---|---|---|---|---|
| NUM. | r | d | nd | vd | RADIUS (mm) |
| 1* | 0.7162 | 0.0908 | 1.56797 | 34.86 | 0.23 |
| STO | INFINITY | 0.4495 | 1.61690 | 61.89 | 0.20 |
| 3 | INFINITY | 0.0500 | 1.51621 | 56.22 | 0.31 |
| 4* | 0.7752 | 0.1011 | | | 0.34 |
| 5* | 0.5978 | 0.1162 | 1.58797 | 34.86 | 0.43 |
| 6 | INFINITY | 0.3000 | 1.51690 | 61.89 | 0.45 |
| 7 | INFINITY | 0.0500 | 1.56797 | 34.86 | 0.68 |
| 8* | 1.9000 | 0.1243 | | | 0.60 |
| 9 | INFINITY | 0.3500 | 1.47400 | 56.39 | 0.65 |
| 10 | INFINITY | 0.0433 | | | 0.76 |
| IMG | INFINITY | 0.0000 | | | |

ASPHERICAL SURFACE

| | |
|---|---|
| 1 | K = 1.63852e+000, A4 = −1.80796e+000, A6 = 7.94612e+001, A8 = −1.19878e+003, |
| | A10 = −1.69899e+004, A12 = 3.59654e+005, A14 = −5.59776e+003, |
| | A16 = 0.00000e+000, A18 = 0.00000e+000, A20 = 0.00000e+000 |
| 4 | K = 3.37085e+000, A4 = −7.11108e+000, A6 = 5.42615e+001, A8 = 2.27609e+001, |
| | A10 = −5.48999e+003, A12 = 1.46821e+004, A14 = 2.66247e+005, |
| | A16 = 3.80384e+005, A18 = −2.82273e+007, A20 = 1.10965e+008 |
| 5 | K = −6.62958e+000, A3 = 0.00000e+000, A4 = −5.89068e−001, A5 = 0.00000e+000, |
| | A6 = −4.99500e+001, A7 = 0.00000e+000, A8 = 1.36828e+003, A9 = 0.00000e+000, |
| | A10 = −1.74848e+004, A11 = 0.00000e+000, A12 = 1.19014e+005, A13 = 0.00000e+000, |
| | A14 = −4.19325e+005, A15 = 0.00000e+000, A16 = 6.00317e+005, A17 = 0.00000e+000, |
| | A18 = 0.00000e+000, A19 = 0.00000e+000, A20 = 0.00000+000 |
| 8 | K = −3.00000e+001, A4 = 2.45420e−001, A6 = −6.42940e+000, A8 = 4.01126e+001, |
| | A10 = −1.41069e+002, A12 = 2.28523e+002, A14 = −1.40232e+002, |
| | A16 = −1.28821e+002, A18 = 1.03712e+003, A20 = −1.73654e+003 |

f = 1.17 mm
fB = 0.68 mm
Fno = 2.87
2Y = 1.43 mm
ENTP = 0.06 mm
EXTP = −1.06 mm
H1 = 0.01 mm
H2 = −1.10 mm

| SINGLE LENS DATA | | |
|---|---|---|
| LENS | STARTING SURFACE | FOCAL LENGTH (mm) |
| 1 | 1 | 2.975 |
| 2 | 5 | 1.346 |

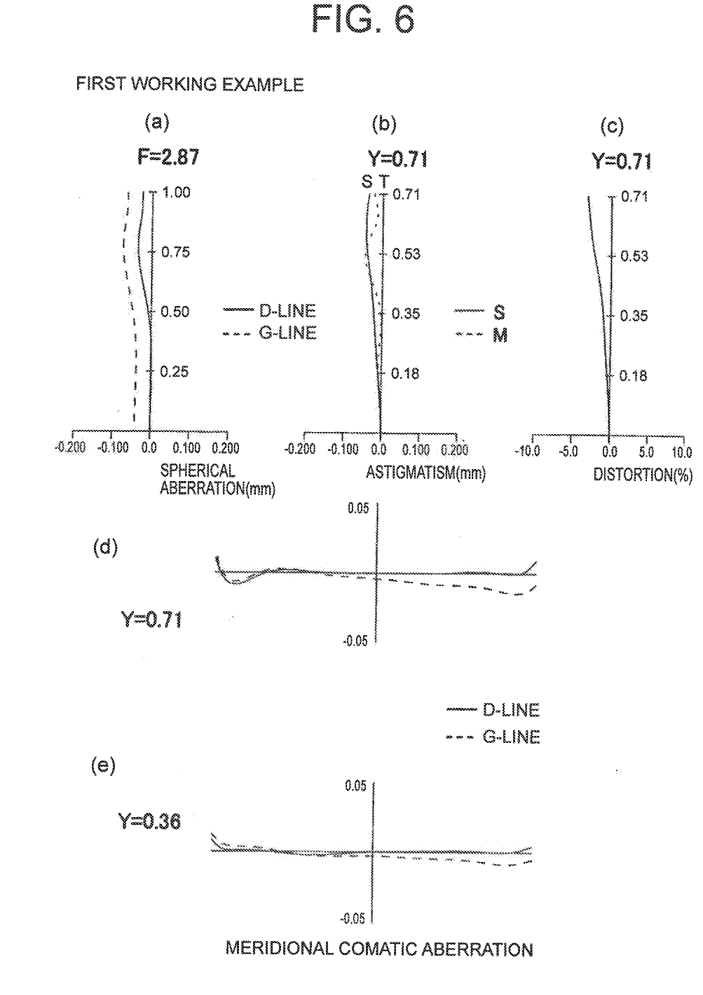

FIG. 6 illustrates diagrams of aberrations (a spherical aberration (a), an astigmatism (b), a distortion (c) and meridional comatic aberrations (d), (e)) in the first working example. Herein, in the diagram of the spherical aberration and the diagram of the meridional comatic aberration, the spherical aberrations and the meridional comatic aberrations are indicated by the solid line with respect to the d-line and the dotted line with respect to the g-line, respectively; and in the diagram of the astigmatism, the solid line indicates a sagittal surface, while the dotted line indicates a meridional surface the same shall apply hereinafter).

### Second Working Example

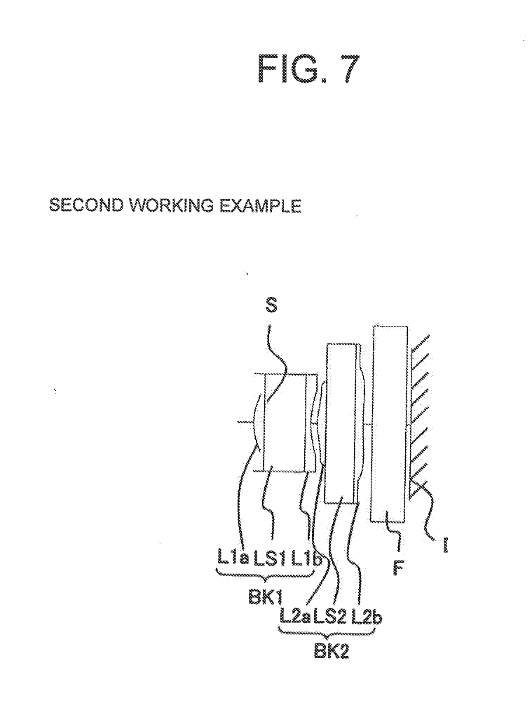

Table 2 shows the lens data in a second working example. FIG. 7 is a sectional view of the lenses in the second working example. The first lens block BK1 having the positive power is configured to include, sequentially from the object side, the first object-side lens unit L1a convexed toward the object side, the aperture stop S, the first lens substrate LS1 having the function as the IR cut filter and the first image-side lens unit L1b concaved toward the image side; next the second lens block BK2 having the positive power is configured to include the second object-side lens unit L2a convexed toward the object side, the second lens substrate LS2 and the second image-side paraxial lens unit L2b convexed toward the image side; and finally the parallel-plane plate PT assumed to use the seal glass etc. of the solid-state image capturing element is provided. Herein, the IR cut filter serves also as the first lens substrate LS1, however, the parallel-plane plate PT may be used as the IR cut filter, and further the IR cut filter may be added as another member of the parallel-plane plate. The symbol “I” denotes the image capturing surface of the image capturing element. Only the second image-side lens unit L2b has the inflection point.

TABLE 2
SECOND WORKING EXAMPLE
SURF DATA

| | | | | | EFFECTIVE |
|---|---|---|---|---|---|
| NUM. | r | d | nd | vd | RADIUS (mm) |
| 1* | 0.6309 | 0.1080 | 1.56797 | 34.86 | 0.23 |
| STO | INFINITY | 0.4183 | 1.51690 | 61.89 | 0.19 |
| 3 | INFINITY | 0.0556 | 1.51621 | 56.22 | 0.29 |
| 4* | 0.7035 | 0.0704 | | | 0.32 |
| 5* | 0.6986 | 0.0885 | 1.56797 | 34.86 | 0.38 |
| 6 | INFINITY | 0.2991 | 1.51690 | 61.89 | 0.40 |
| 7 | INFINITY | 0.0836 | 1.56797 | 34.86 | 0.54 |
| 8* | 3.3983 | 0.0971 | | | 0.56 |
| 9 | INFINITY | 0.3500 | 1.47400 | 56.39 | 0.62 |
| 10 | INFINITY | 0.0495 | | | 0.73 |
| IMG | INFINITY | 0.0000 | | | |

ASPHERICAL SURFACE

| | |
|---|---|
| 1 | K = 3.57147e+000, A4 = −2.65721e+000, A6 = 5.98609e+000, |
| | A8 = 1.40142e+002, A10 = -1.58713e+004, A12 = 2.92840e+005, A14 = −2.46901e+006, |
| | A16 = 0.00000e+000, A18 = 0.00000e+000, A20 = 0.00000e+000 |
| 4 | K = 2.89479e+000, A4 = −6.78254e+000, A6 = 4.55164e+001, A8 = 3.28009e+001, |
| | A10 = −4.47720e+003, A12 = 2.46742e+004, A14 = 7.29291e+004, |
| | A16 = −1.50213e+006, A18 = 7.10580e+006, A20 = −1.92215e+007 |
| 5 | K = −1.05984e+001, A3 = 0.00000e+000, A4 = −1.30286e+000, |
| | A5 = 0.00000e+000, A6 = −4.69738e+001, A7 = 0.00000e+000, A8 = 1.34210e+003, |
| | A9 = 0.00000e+000, A10 = −1.76089e+004, A11 = 0.00000e+000, A12 = 1.19307e+005, |
| | A13 = 0.00000e+000, A14 = −4.12951e+005, A15 = 0.00000+000, A16 = 6.22835e+005 |
| | A17 = 0.00000e+000, A18 = 0.00000e+000, A19 = 0.00000e+000, A20 = 0.00000e+000, |
| 8 | K = −4.60225e+000, A4 = 3.28104e−002, A6 = −8.23353e+000, A8 = 4.39720e+001, |
| | A10 = −1.38278e+002, A12 = 2.23190e+002, A14 = −1.69925e+002, |
| | A16 = −1.96718e+002, A18 = 9.90476e+002, A20 = −6.07439e+002 |

f = 1.14 mm
fB = 0.66 mm
Fno = 2.87
2Y = 1.43 mm
ENTP = −0.07 mm
EXTP = −l.00 mm
H1 = −0.02 mm
H2 = −1.09 mm

| SINGLE LENS DATA | | |
|---|---|---|
| LENS | STARTING SURFACE | FOCAL LENGTH (mm) |
| 1 | 1 | 2.360 |
| 2 | 5 | 1.444 |

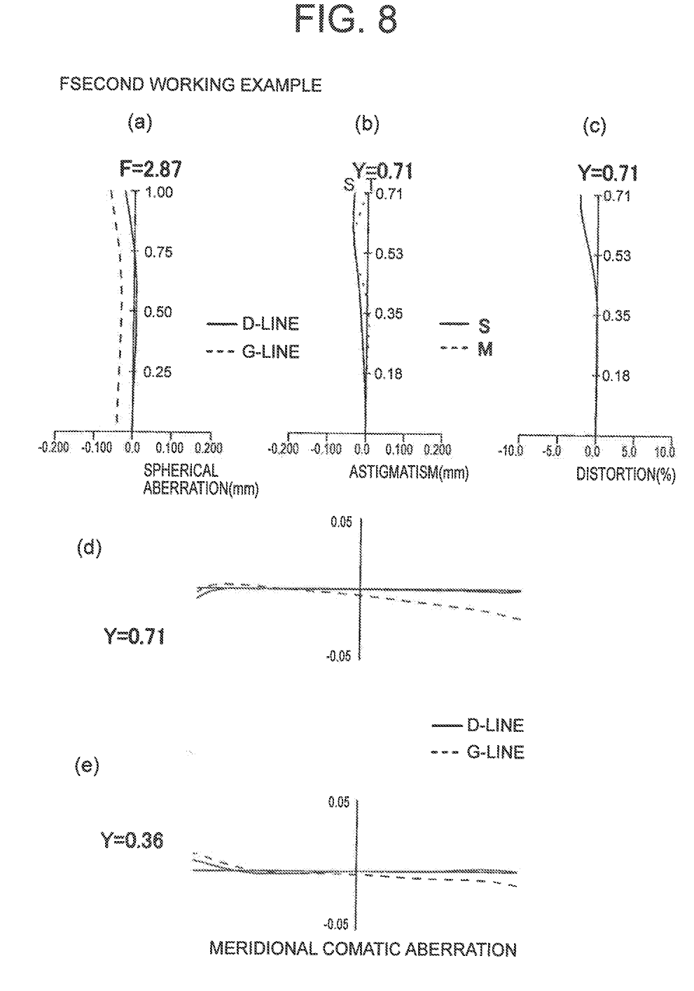

FIG. 8 illustrates diagrams of aberrations the spherical aberration (a), the astigmatism (b), the distortion (c) and the meridional comatic aberrations (d), (e)) in the second working example.

### Third Working Example

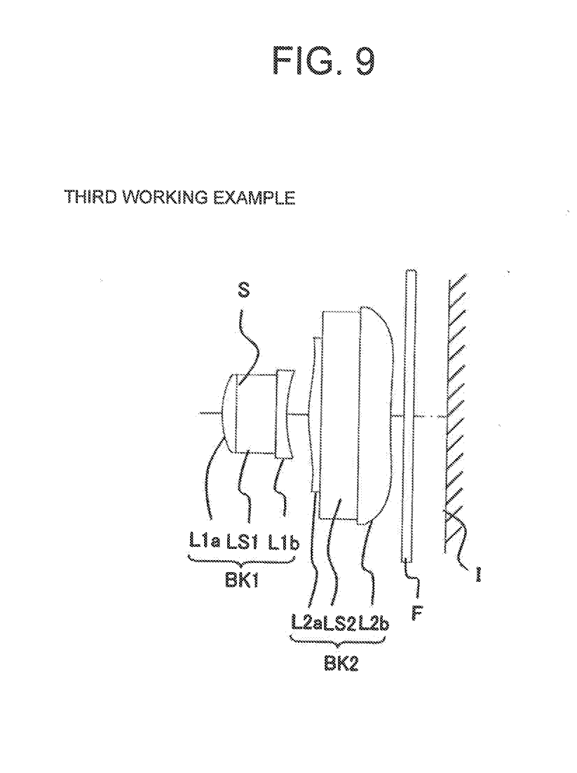

Table 3 shows the lens data in a third working example. FIG. 9 is a sectional view of the lenses in the third working example. The first lens block BK1 having the positive power is configured to include, sequentially from the object side, the first object-side lens unit L1a convexed toward the object side, the aperture stop S, the first lens substrate LS1 having the function as the IR cut filter and the first image-side lens unit L1b concaved toward the image side; next the second lens block BK2 having the positive power is configured to include the second object-side lens unit L2a convexed toward the object side, the second lens substrate LS2 and the second image-side paraxial lens unit L2b convexed toward the image side; and finally the parallel-plane plate PT assumed to use the seal glass etc. of the solid-state image capturing element is provided. Herein, the IR cut filter serves also as the first lens substrate LS1, however, the parallel-plane plate PT may be used as the IR cut filter, and further the IR cut filter may be added as another member of the paraliel-plane plate. The symbol. “I” denotes the image capturing surface of the image capturing element. The second object-side lens L2a and, the second image-side lens unit L2b have the inflection points.

TABLE 3
THIRD WORKING EXAMPLE
SURF DATA

| | | | | | EFFECTIVE |
|---|---|---|---|---|---|
| NUM. | r | d | nd | vd | RADIUS (mm) |
| 1* | 0.8795 | 0.1460 | 1.56889 | 34.76 | 0.34 |
| STO | INFINITY | 0.4050 | 1.51690 | 61.89 | 0.29 |
| 3 | INFINITY | 0.1060 | 1.56889 | 34.76 | 0.40 |
| 4* | 1.4558 | 0.2280 | | | 0.45 |
| 6* | 1.4871 | 0.1300 | 1.56889 | 34.76 | 0.74 |
| 6 | INFINITY | 0.4000 | 1.51690 | 61.89 | 0.79 |
| 7 | INFINITY | 0.3340 | 1.51665 | 56.19 | 1.07 |
| 8* | 10.9560 | 0.1390 | | | 1.12 |
| 9 | INFINITY | 0.1000 | 1.51633 | 64.14 | 1.22 |
| 10 | INFINITY | 0.3500 | | | 1.26 |
| IMC | INFINITY | 0.0000 | | | |

ASPHERICAL SURFACE

| | |
|---|---|
| 1 | K = −5.02310e+000, A3 = −2.67170e−001, A4 = 2.64960e+000, A5 = 0.00000e+000, |
| | A6 = −2.85960e+001, A7 = 0.00000e+000, A8 = 2.62010e+002, A9 = 0.00000e+000, |
| | A10 = −4.01770e+002, A11 = 0.00000e+000 A12 = −8.69680e+003, A13 = 0.00000e+000, |
| | A14 = 2.40200e+004, A15 = 0.00000e+000, A16 = 1.13680e+005 A17 = 0.00000e+000, |
| | A18 = 0.00000e+000, A19 = 0.00000e+000, A20 = 0.00000e+000 |
| 4 | K = −1.92880e−001, A3 = 5.46250e−001, A4 = −3.81010e+000, A5 = 0.00000e+000, |
| | A6 = 3.76380e+001, A7 = 0.00000e+000, A8 = −2.37260e+002, A9 = 0.00000e+000, |
| | A10 = 8.17710e+002, A11 = 0.00000e+000 A12 = −1.13440e+003, A13 = 0.00000e+000, |
| | A14 = 0.00000e+000, A15 = 0.00000e+000, A16 = 0.00000e+000, A17 = 0.00000e+000, |
| | A18 = 0.00000e+000, A19 = 0.00000e+000, A20 = 0.00000e+000, |
| 5 | K = −1.35170e+001, A4 = −3.65670e−001, A6 = 1.62440e+000, A8 = −1.70780e+001, |
| | A10 = 7.76970e+001, A12 = −1.23320e+002, A14 = −8.84220e+001, |
| | A16 = 4.58640e+002, A18 = −3.92410e+002, A20 = 5.74260e+001 |
| 8 | K = − 5.00000e+001, A4 = 2.42940e−001, A6 = −9.93490e−001, A8 = 1.05250e+000, |
| | A10 = −5.14930e−001, A12 = 6.51810e−002, A14 = 0.00000e+000, |
| | A16 = 0.00000e+000, A18 = 0,00000e+000, A20 = 0.00000e+000 |

f = 1.67 mm
fB = 0.64 mm
Fno = 2.79
2Y = 2.59 mm
ENTP = 0.10 mm
EXTP = −1.36 mm
H1 = −0.07 mm
H2 = −1.39 mm

| SINGLE LENS DATA | | |
|---|---|---|
| LENS | STARTING SURFACE | FOCAL LENGTH (mm) |
| 1 | 1 | 2.724 |
| 2 | 5 | 2.873 |

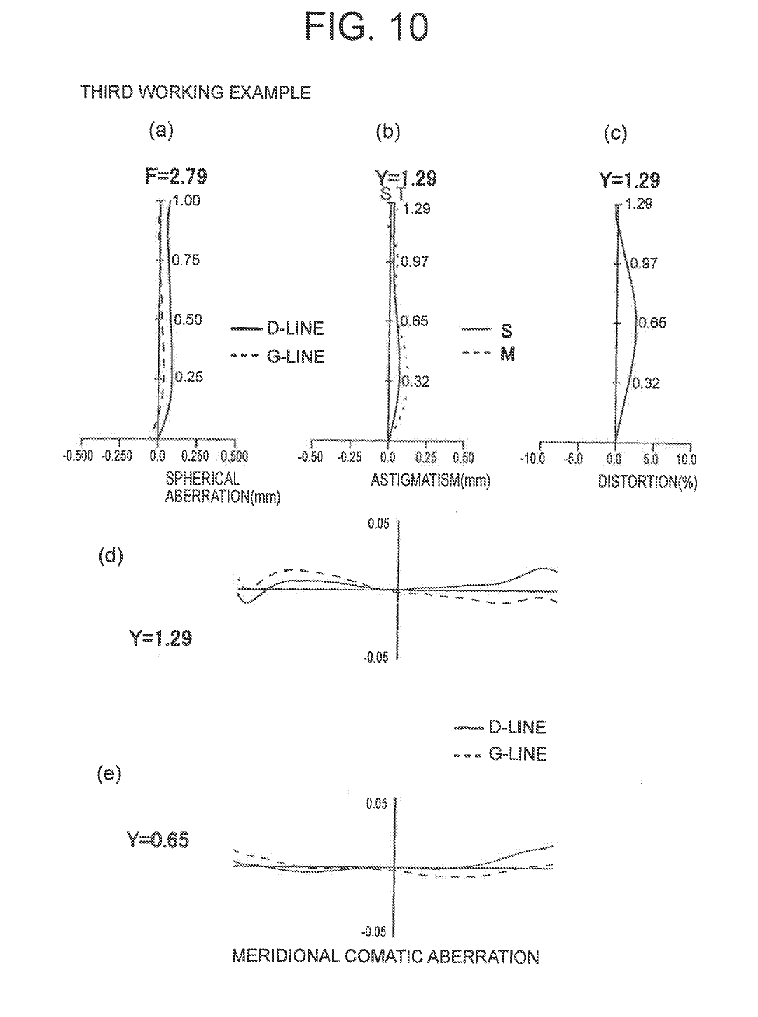

FIG. 10 illustrates diagrams of aberrations (the spherical aberration (a), the astigmatism (b), the distortion (c) and the meridional somatic aberrations (d), (e)) in the third working example.

### Fourth Working Example

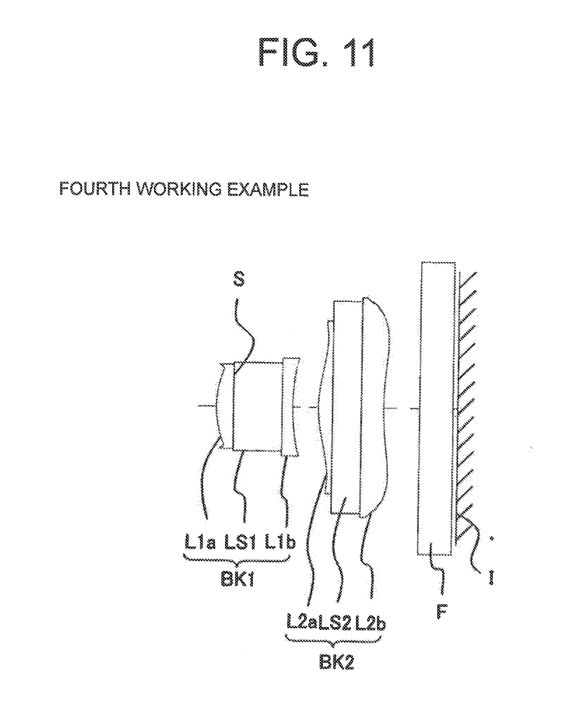

Table 4 shows the lens data in a fourth working example. FIG. 11 is a sectional view of the lenses in the fourth working example. The first lens block BK1 having the positive power is configured to include, sequentially from the object side, the first object-side lens unit Lla convexed toward the object side, the aperture stop S, the first lens substrate LS1 having the function as the IR cut filter and the first image-side lens unit L1b concaved toward the image side; next the second lens block BK2 having the positive power is configured to include the second object-side lens unit L2a convexed toward the object side, the second lens substrate LS2 and the second image-side paraxial lens unit L2b convexed toward the image side; and finally the parallel plane plate PT assumed to use the seal glass etc. of the solid-state image capturing element is provided. Herein, the IR cut filter serves also as the first lens substrate LS1, however, the parallel-plane plate PT may be used as the IR cut filter, and further the IR cut filter may be added as another member of the parallel-plane plate. The symbol “I” denotes the image capturing surface of the image capturing element. The second object-side lens L2a and the second image-side lens unit L2b have the inflection points.

TABLE 4
FOURTH WORKING EXAMPLE
SURF DATA

| | | | | | EFFECTIVE |
|---|---|---|---|---|---|
| NUM. | r | d | nd | vd | RADIUS (mm) |
| 1* | 0.9468 | 0.1770 | 1.52114 | 53.44 | 0.37 |
| STO | INFINITY | 0.5000 | 1.51690 | 61.89 | 0.30 |
| 3 | INFINITY | 0.1090 | 1.59009 | 29.75 | 0.45 |
| 4* | 1.9378 | 0.2710 | | | 0.50 |
| 5* | 1.1278 | 0.1480 | 1.52114 | 53.44 | 0.85 |
| 6 | INFINITY | 0.3000 | 1.51690 | 61.89 | 0.89 |
| 7 | INFINITY | 0.2340 | 1.52114 | 53.44 | 1.09 |
| 8* | 3.1189 | 0.3760 | | | 1.12 |
| 9 | INFINITY | 0.3500 | 1.47140 | 66.01 | 1.22 |
| 10 | INFINITY | 0.0500 | | | 1.30 |
| IMG | INFINITY | 0.0000 | | | |

ASPHERICAL SURFACE

| | |
|---|---|
| 1 | K = −1.84400e+000, A3 = −2.05000e−001, A4 = 1.49860e+000, |
| | A5 = 0.00000e+000, A6 = −2.15310e+001, A7 = 0.00000e+000, |
| | A8 = 2.89340e+002, A9 = 0.00000e+000, A10 = −1.17210e+003, |
| | A11 = 0.00000e+000 A12 = −1.70800e+004, A13 = 0.00000e+000, |
| | A14 = 2.16530e+005, A15 = .0.00000e+000, A16 = −7.05770e +005 |
| | A17 = 0.00000e+000, A18 = 0.00000e+000, A19 = 0.00000e+000, A20 = 0.00000e+000 |
| 4 | K = 1.15200e+001, A3 = 4.37300e−001, A4 = −3, 24120e+000, |
| | A5 = 0.00000e+000, A6 = 2.38770e +001, A7 = 0.00000e+000, |
| | A7 = −1.26700e+002, A9 = 0.00000e+000, A10 = 3.76110e+002, |
| | A11 = 0.00000e+000 A12 = −4.87880e+002, A13 = 0.00000e+000, |
| | A14 = 0.00000e+000, A15 = 0.00000e+000, A16 = 0.00000e+000, |
| | A17 = 0.00000e+000, A18 = 0.00000e+000, A19 = 0.00000e+000, A20 = 0.00000e+000 |
| 5 | K = −4.74970e+000, A3 = −0.00000e+000, A4 = −5.27890e−001, |
| | A5 = 0.00000e+000, A6=2.09590e+000, A7 = 0.00000e+000, |
| | A8 = −1.19870e+001, A9 = −0.00000e+000, A10 = 3.74570e+001, |
| | A11 = 0.00000e+000, A12 = −4.90770e+001, A13 = 0.00000e+000, |
| | A14 = −1.97510e +001, A15 = 0.00000e+000, A16 = 1.36860e+002 |
| | A17 = −0.00000e+000, A18 = −1.52550e+002, A19 = 0.00000e+000, A20 = 5.83250e+001 |
| 8 | K = −4.37270e+000, A3 = 0.00000e+000, A4 = 7.63500e−002, |
| | A5 = 0.00000e+000, A6 = −6.48560e−001, A7 = 0.00000e+000, |
| | A8 = 6.92450e−001, A9 = 0.00000e+000, A10 = −3.54340e−001, |
| | A11 = 0.00000e+000 A12 = 4.72060e−002, A13 = 0.00000e+000, |
| | A14 = 0.00000e+000, A15 = 0.00000e+000, A16 = 0.00000e+000 |
| | A17 = 0.00000e+000, A18 = 0.00000e+000, A19 = 0.00000e+000, A20 = 0.00000e+000 |

f = 1.77 mm
fB = 0.94 mm
Fno = 2.80
2Y = 2.59 mm
ENTP = 0.12 mm
EXTP = −1.70 mm
H1 = −0.05 mm
H2 = −1.77 mm

| SINGLE LENS DATA | | |
|---|---|---|
| LENS | STARTING SURFACE | FOCAL LENGTH (mm) |
| 1 | 1 | 3.002 |
| 2 | 5 | 3.019 |

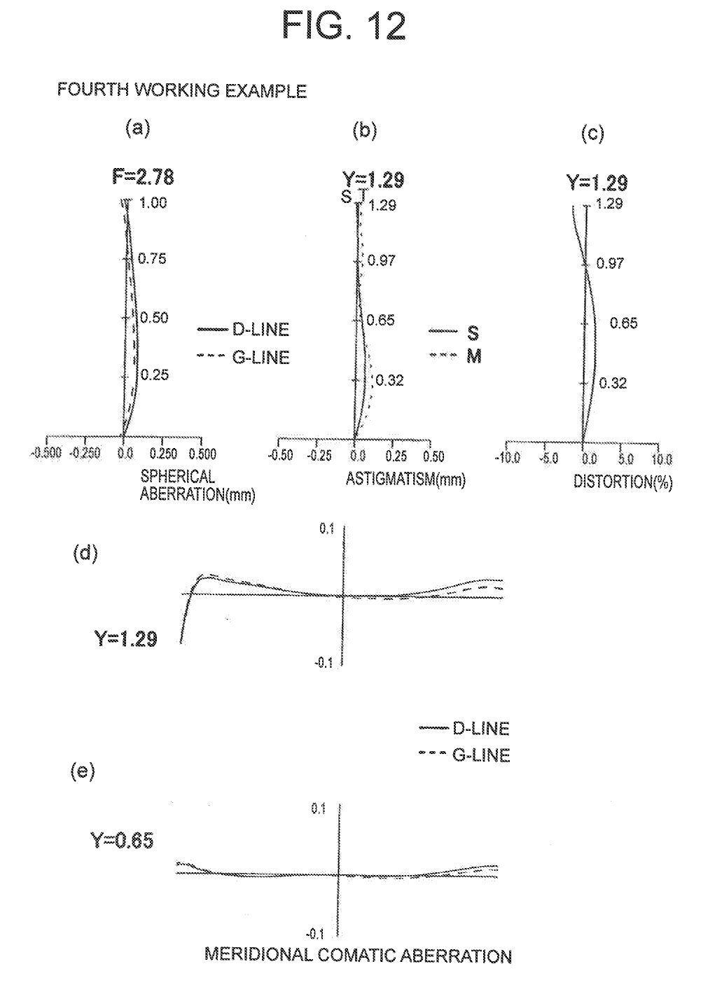

FIG. 12 illustrates diagrams of aberrations the spherical aberration (a), the astigmatism (b), the distortion (c) and the meridional comatic aberrations (d), (e)) in the fourth working example.

### Fifth Working Example

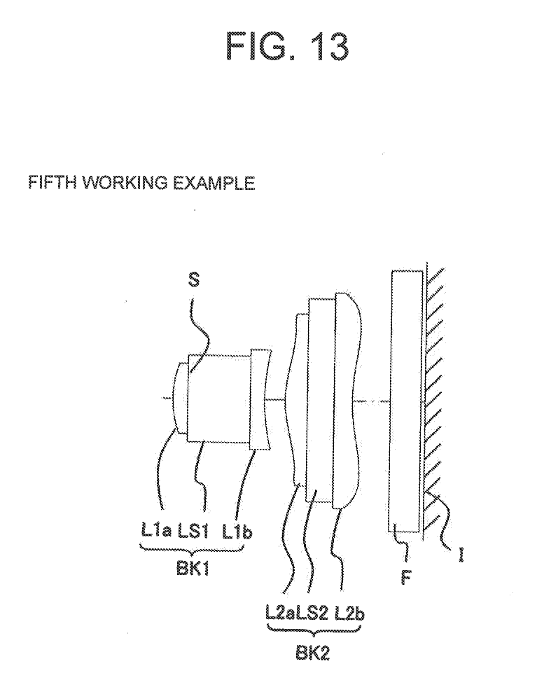

Table 5 shows, the lens data in a fifth working example. FIG. 13 is a sectional view of the lenses in the fifth working example. The first lens block BK1 having the positive power is configured to include, sequentially from the object side, the first object-side lens unit L1a convexed toward the object side, the aperture stop S, the first lens substrate LS1 having the function as the IR cut filter and the first image-side lens unit L1b concaved toward the image side; next the second lens block BK2 having the positive power is configured to include the second object-side lens unit L2a convexed toward the object side, the second lens substrate LS2 and the second image-side paraxial lens unit L2b convexed toward the image side; and finally the parallel-plane plate PT assumed to use the seal class etc. of the solid-state image capturing element is provided. Herein, the IR cut filter serves also as the first lens substrate LS1, however, the parallel-plane plate PT may be used as the IR cut filter, and further the IR cut filter may be added as another member of the parallel-plane plate. The symbol “I” denotes the image capturing surface of the image capturing element. The second object-side lens L2a and the second image-side lens unit L2b have the inflection points.

TABLE 5
FIFTH WORKING EXAMPLE
SURF DATA

| | | | | | EFFECTIVE |
|---|---|---|---|---|---|
| NUM. | r | d | nd | vd | RADIUS (mm) |
| 1* | 1.1247 | 0.1680 | 1.51665 | 56.27 | 0.40 |
| STO | INFINITY | 0.7150 | 1.51690 | 61.89 | 0.35 |
| 3 | INFINITY | 0.1620 | 1.57970 | 34.86 | 0.50 |
| 4* | 1.9182 | 0.2380 | | | 0.57 |
| 5* | 1.0971 | 0.2550 | 1.57970 | 34.86 | 0.91 |
| 6 | INFINITY | 0.3100 | 1.51690 | 61.89 | 0.98 |
| 7 | INFINITY | 0.2120 | 1.51665 | 56.27 | 1.16 |
| 8* | 1.9264 | 0.4410 | | | 1.23 |
| 9 | INFINITY | 0.3500 | 1.47140 | 66.01 | 1.40 |
| 10 | INFINITY | 0.0500 | | | 1.49 |
| IMG | INFINITY | 0.0000 | | | |

ASPHERICAL SURFACE

| | |
|---|---|
| 1 | K = 1.04480e+000, A3 = −1.79460e−001, A4 = 1.86270e+000, |
| | A5 = 0.00000e+000, A6 = −6.33560e+001, A7 = 0.00000e+000, |
| | A8 = 1.40940e+003, A9 = 0.00000e+000, A10 = −1.80010e+004, |
| | A11 = 0.00000e+000 A12 = 1.28330e+005, A13 = 0.00000e+000, |
| | A14 = −4.74620e+005, A15 = 0.00000e+000, A16 = 7.08650e+005 |
| | A17 = 0.00000e+000, A18 = 0.00000e+000, A19 = 0.00000e+000, A20 = 0.00000e+000 |
| 4 | K = 9.17360e+000, A3 = 4.56620e−001, A4 = −3.04150e+000, |
| | A5 = 0.00000e−000, A6 = 1.64360e+001, A7 = 0.00000e+000, |
| | A8 = −6.86220e+001, A9 = 0.00000e+000, A10 = 1.60170e+002, |
| | A11 = 0.00000e+000 A12 = −1.65410e+002, A13 = 0.00000e+000, |
| | A14 = −7.95550e+000, A15 = 0.00000e+000, A16 = 9.37880e+000 |
| | A17 = 0.00000e+000, A18 = 0.00000e+000, A19 = 0.00000e +000, A20 = 0.0000e+000 |
| 5 | K = −4.96690e+000, A4 = −5.41780e−001, A6 = 1.68470e4+000, |
| | A8 = −8.096800000, A10 = 1.49300e+001, A12 = −1.86000e+001, |
| | A14 = 6.86550e+000, A16 = 5.13250e+000, A18 = −3.53730e+000, A20 = 0.00000e+000 |
| 8 | K = −8.60340e+001, A4 = −1.10750e−001, A6 = −3.47050e−001, A8 = 5.19040e−001, |
| | A10 = −3.06260e−001, A12 = −5.21310e−002, A14 = −7.56900e−005, |
| | A16 = 1.77310e−003, A18 = 0.00000e+000, A20 = 0.00000e+000 |

f = 2.01 mm
fB = 1.01 mm
Fno = 2.82
2Y = 2.84 mm
ENTP = 0.12 mm
EXTP = −1.84 mm
H1 = −0.09 mm
H2 = −2.03 mm

| SINGLE LENS DATA | | |
|---|---|---|
| LENS | STARTING SURFACE | FOCAL LENGTH (mm) |
| 1 | 1 | 3.952 |
| 2 | 5 | 2.985 |

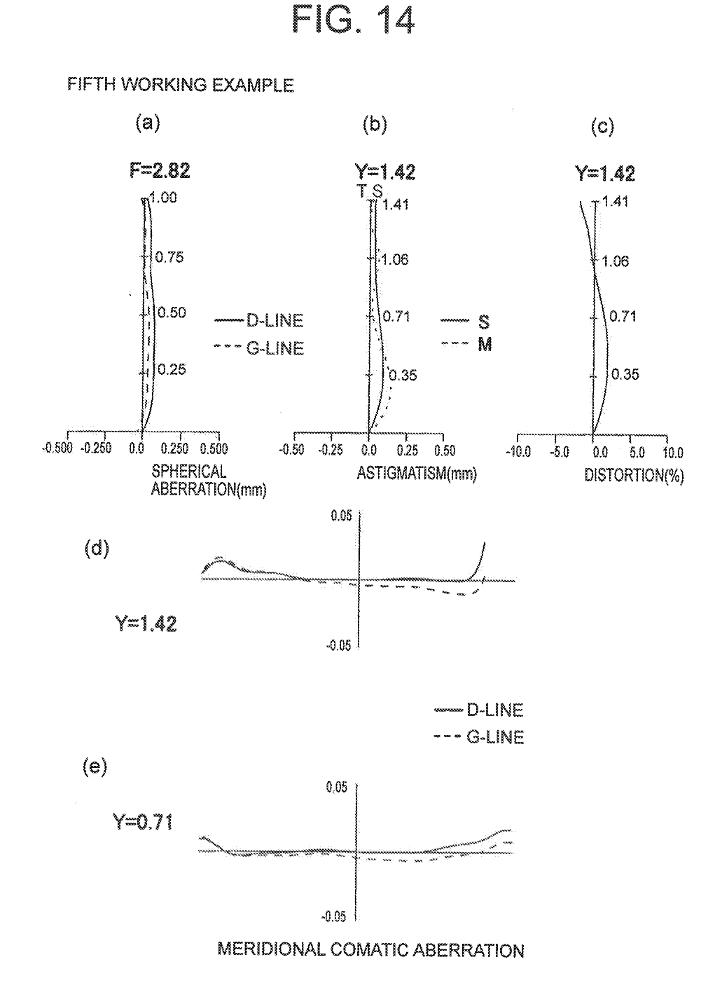

FIG. 14 illustrates diagrams of aberrations (the spherical aberration (a), the astigmatism (b), the distortion (c) and the meridional comatic aberrations (d), (e)) in the fifth working example.

### Sixth Working Example

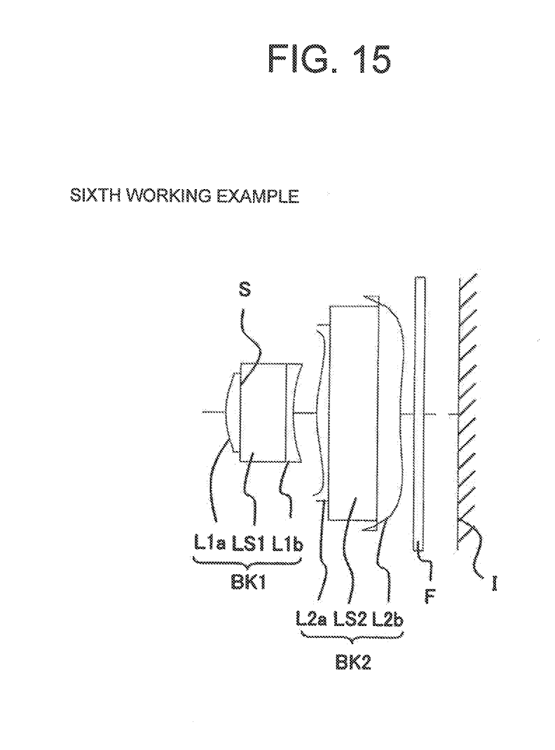

Table 6 shows the lens data in a sixth working example. FIG. 15 is a sectional view of the lenses in the sixth working example. The first lens block BK1 having the positive power is configured to include, sequentially from the object side, the first object-side lens unit L1a convexed toward the object side, the aperture stop S, the first lens substrate LS1 having the function as the IR cut filter and the first image-side lens unit L1b concaved toward the image side; next the second lens block BK2 having the positive bower is configured to include the second object-side lens unit L2a convexed toward the object side, the second lens substrate LS2 and the second image-side paraxial lens unit L2b convexed toward the image side; and finally the parallel-plane plate PT assumed to use the seal glass etc. of the solid-state image capturing element is provided. Herein, the IR cut filter serves also as the first lens substrate LS1, however, the parallel-plane plate PT may be used as the IR cut filter, and further the IR cut filter may be added as another member of the parallel-plane plate. The symbol “I” denotes the image capturing surface of the image capturing element. The second object-side lens L2a and the second image-side lens unit L2b have the inflection points.

TABLE 6
SIXTH WORKING EXAMPLE
SURF DATA

| | | | | | EFFECTIVE |
|---|---|---|---|---|---|
| NUM. | r | d | nd | vd | RADIUS (mm) |
| 1* | 0.9311 | 0.1437 | 1.58889 | 34.76 | 0.34 |
| STO | INFINITY | 0.4567 | 1.51690 | 61.89 | 0.29 |
| 3 | INFINITY | 0.0752 | 1.56889 | 34.78 | 0.42 |
| 4* | 1.5374 | 0.2387 | | | 0.47 |
| 5* | 1.3332 | 0.1270 | 1.58889 | 34.76 | 0.71 |
| 6 | INFINITY | 0.5000 | 1.51690 | 61.89 | 0.74 |
| 7 | INFINITY | 0.2295 | 1.51665 | 56.19 | 1.10 |
| 8* | 5.0558 | 0.1455 | | | 1.12 |
| 9 | INFINITY | 0.1000 | 1.51633 | 64.14 | 1.24 |
| 10 | INFINITY | 0.3549 | | | 1.27 |
| IMG | INFINITY | 0.0000 | | | |

ASPHERICAL SURFACE

| | |
|---|---|
| 1 | K = −1.19934e+001, A3 = −1.49115e−001, A4 = 2.71362e+000, |
| | A5 = 0.00000e+000, A6 = −2.44427e+001, A7 = 0.00000e+000, |
| | A8 = 2.29380e+002, A9 = 0.00000e+000, A10 = −1.01908e+003, |
| | A11 = 0.00000e+000 A12 = −3.14220e+003, A13 = 0.00000e+000, |
| | A14 = 6.37709e+004, A15 = −0.00000e+000, A16 = −2.59594e+005 |
| | A17 = 0.00000e+000, A18 = 0.00000e+000, A19 = 0.00000e+000, A20 = 0.00000e+000 |
| 4 | K = −4.44472e+000, A3 = 5.30727e−001, A4 = −3.630310+000, |
| | A5 = 0.00000e+000, A6 = 3.65321e+001, A7 = 0.00000e+000, |
| | A8 = −2.31732e+002, A9 = 0.00000e+000, A10 = 8.09827e+002, |
| | A11 = 0.00000e+000 A12 = −1.16221e+003, A13 = 0.00000e+000, |
| | A14 = 0.00000e+000, A15 = 0.00000e+000, A16 = 0.00000e+000 |
| | A17 = 0.00000e−000, A18 = 0.00000e+000, A19 = 0.00000e+000, A20 = 0.00000e+000 |
| 5 | K = −7.02086e+000, A3 = 0.00000e+000, A4 = −5.48648e−001, |
| | A5 = 0.00000e+000, A6 = 2.55926e+000, A7 = 0.00000e+000, |
| | A8 = − 1.85474e+001, A9 = 0.00000e+000, A10 = 7.37080e+001, |
| | A11 = 0.00000e+000 A12 = −1.15119e+002, A13 = 0.00000e+000, |
| | A14 = −6.33531e+001, A15 = 0.00000e+000, A16 = 4.34214e+002 |
| | A17 = 0.00000e+000, A18 = −5.02774e+002, A19 = 0.00000e+000, A20 = 1.87133e+002 |
| 8 | K = −4.99952e+001, A3 = 0.00000e+000, A4 = 1.56188e+001, |
| | A5 = 0.00000e+000, A6 = −6.66599e−001, A7 = 0.00000e+000, |
| | A8 = 5.38713e−001, A9 = 0.00000e+000, A10 = −9.76098e−002, |
| | A11 = 0.00000e+000 A12 = −5.94994e−002, A13 = 0.00000e+000, |
| | A14 = 0.00000e+000, A15 = 0.00000e+000, A16 = 0.00000e+000 |
| | A17 = 0.00000e+000, A18 = 0.00000e+000, A19 = 0.00000e+000, A20 = 0.00000e+000 |

f = 1.69 mm
fB = 0.65 mm
Fno = 2.79
2Y = 2.59 mm
ENTP = 0.10 mm
EXTP = −1.34 mm
H1 = −0.04 mm
H2 = −1.40 mm

| SINGLE LENS DATA | | |
|---|---|---|
| LENS | STARTING SURFACE | FOCAL LENGTH (mm) |
| 1 | 1 | 2.912 |
| 2 | 5 | 2.843 |

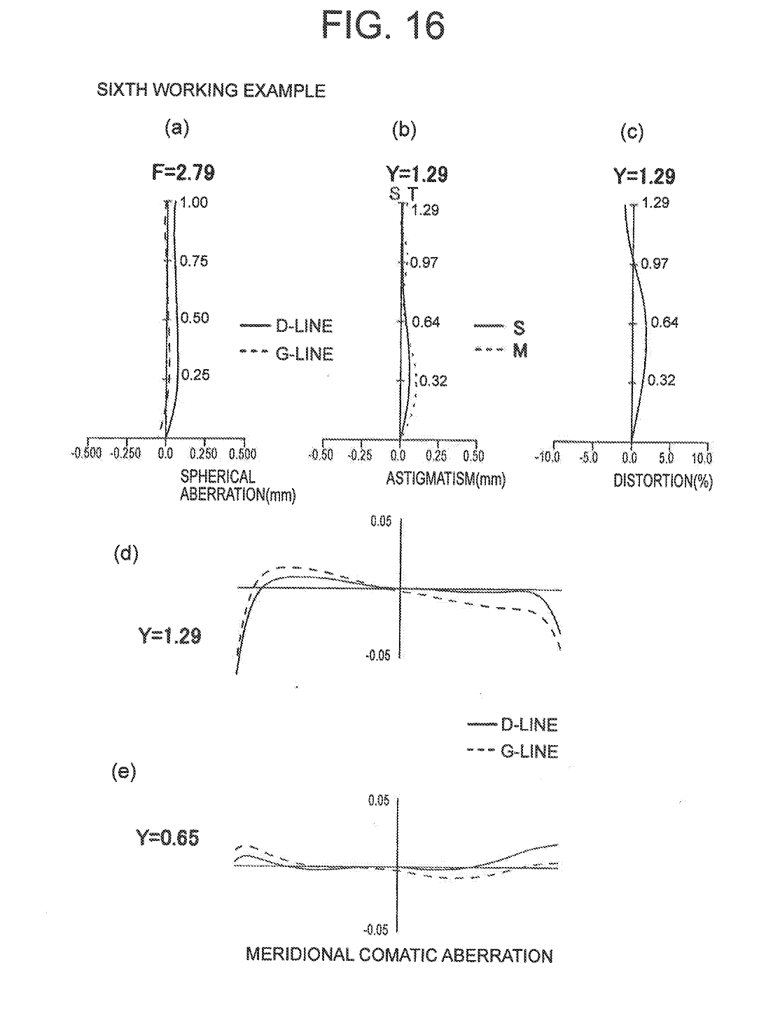

FIG. 16 illustrates diagrams of aberrations (the spherical aberration (a), the astigmatism (b), the distortion (c) and the meridional comatic aberrations (d), (e)) in the sixth working example.

### Seventh Working Example

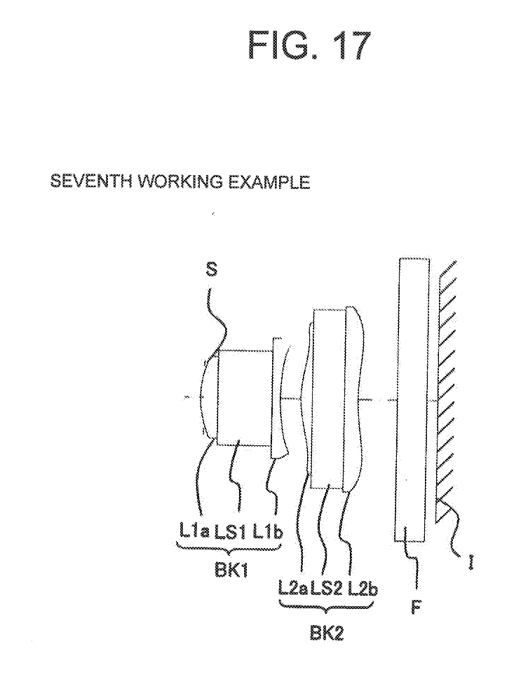

Table 7 shows the lens data in a seventh working example. FIG. 17 is a sectional view of the lenses in the seventh working example. The first lens block BK1 having the positive power is configured to include, sequentially from the object side, the first object-side lens unit L1a convexed toward the object side, the aperture stop 5, the first lens substrate LS1 having the function as the IR cut filter and the first image-side lens unit L1b concaved toward the image side; next the second lens block BK2 having the positive power is configured to include the second object-side lens unit L2a convexed toward the object side, the second lens substrate LS2 and the second image-side paraxial lens unit L2b convexed toward the image side; and finally the parallel-plane plate PT assumed to use the seal glass etc. of the solid-state image capturing element is provided. Herein, the IR cut filter serves also as the first lens substrate LS1, however, the parallel-plane plate PT may be used as the IR cut filter, and further the IR cut filter may be added as another member of the parallel-plane plate. The symbol “I” denotes the image capturing surface of the image capturing element. The second object-side lens L2a and the second image-side lens unit L2b have the inflection points.

TABLE 7
SEVENTH WORKING EXAMPLE
SURF DATA

| | | | | | EFFECTIVE |
|---|---|---|---|---|---|
| NUM. | r | d | nd | vd | RADIUS (mm) |
| STO | INFINITY | 0.0090 | | | 0.36 |
| 2 | INFINITY | −0.0400 | | | 0.36 |
| 3* | 1.0838 | 0.1979 | 1.51665 | 56.27 | 0.38 |
| 4 | INFINITY | 0.6311 | 1.51690 | 61.89 | 0.41 |
| 5 | INFINITY | 0.0967 | 1.57970 | 34.86 | 0.55 |
| 6* | 1.8225 | 0.2446 | | | 0.59 |
| 7* | 0.9894 | 0.1397 | 1.51665 | 56.27 | 0.82 |
| 8 | INFINITY | 0.3800 | 1.51690 | 61.89 | 0.85 |
| 9 | INFINITY | 0.1613 | 1.51665 | 56.27 | 1.04 |
| 10* | 2.0978 | 0.4647 | | | 1.08 |
| 11 | INFINITY | 0.3500 | 1.47140 | 66.01 | 1.25 |
| 12 | INFINITY | 0.1286 | | | 1.36 |
| IMG | INFINITY | 0.0000 | | | |

ASPHER1CAL SURFACE

| | |
|---|---|
| 3 | K = 3.70190e−001, A3 = −1.26111e−001, A4 = 1.69576e+000, |
| | A5 = 0.00000e+000, A6 = −6.27300e+001, A7= 0.00000e+000, |
| | A8 = 1.41202e+003, A9 = 0.00000e+000, A10 = −1.79318e+004, |
| | A11 = 0.00000e+000 A12 = 1.27720e+005, A13 = 0.00000e+000, |
| | A14 = −4.72834e+005, A15 = 0.00000e+000, A16 = 7.00861e+005 |
| | A17 = 0.00000e+000, A18 = 0.00000e+000, A19 = 0.00000e+000, A20 = 0.00000e+000 |
| 6 | K = 4.01450e+000, A3 = 4.26700e−001, A4 = −2.99464e+000, |
| | A5 = 0.00000e+000, A6 = 1.74260e+001, A7 = 0.00000e+000, |
| | A8 = −6.84418e4+001, A9 = 0.00000e+000, A10 = 1.47250e+002, |
| | A11 = 0.00000e+000 A12 = −1.28015e+002, A13 = 0.00000e+000, |
| | A14−0.00000e+000, A15 = 0.00000e+000, A16 = 0.00000e+000 |
| | A17 = 0.00000e+000, A18 = 0.00000e+000, A19 = 0.00000e+000, A20 = 0.00000e+000 |
| 7 | K = −1.33913e+000, A3 = −1.28111e−001, A4 = −7.35677e−001, |
| | A5 = 0.00000e+000, A6 = 1.67689e+000, A7 = 0.00000e+000, |
| | A8 = −5.89545e+000, A9 = 0.00000e+000, A10 = 1.49025e+001, |
| | A11 = 0.00000e+000 A12 = −1.88344e−001, A13 = 0.00000e+000, |
| | A14 = 6.64373e+000, A15 = 0.00000e+000, A16 = 5.19498+000 |
| | A17 = 0.00000 e+000, A18 = −2.62144e+000, A19 = 0.00000e+000, A20 = 0.00000e+000 |
| 10 | K = 1.034490e+000, A3 = −1.22372e−001, A4 = 2.11286e−002, |
| | A5 = 0.00000e+000, A6 = −4.53120e−001, A7 = 0.00000e+000, |
| | A8 = 4.70563e−001, A9 = 0.00000e+000, A10 = −2.77822e−001, |
| | A11 = 0.00000e+000 A12 = 7.26714e−002, A13 = 0.00000e+000, |
| | A14 = −1.64932e−004, A15 = 0.00000e+000, A16 = −6.75649e−003 |
| | A17 = 0.00000e+000, A18 = 0.00000e+000, A19 = 0.00000e+000, A20 = 0.00000e+000 |

f = 2.01 mm
fB = 1.11 mm
Fno = 2.82
2Y = 2.84 mm
ENTP = 0.00 mm
EXTP = −1.86 mm
H1 = −0.09 mm
H2 = −2.00 mm

| SINGLE LENS DATA | | |
|---|---|---|
| LENS | STARTING SURFACE | FOCAL LENGTH (mm) |
| 1 | 1 | 3.976 |
| 2 | 5 | 2.983 |

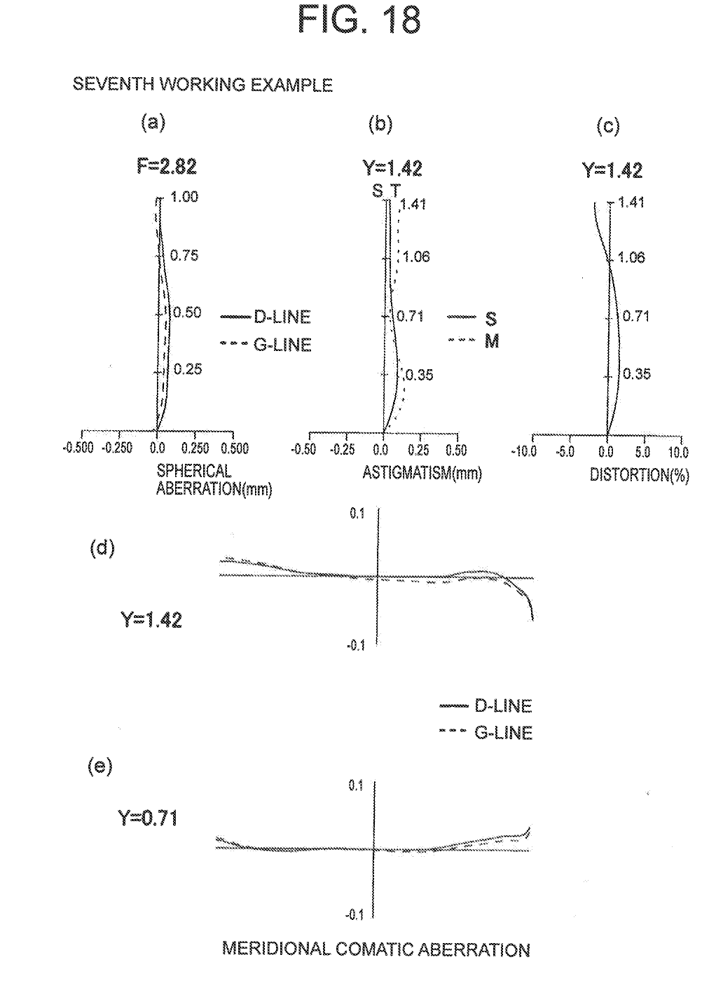

FIG. 18 illustrates diagrams of aberrations (the spherical aberration (a), the astigmatism (b), the distortion (c) and the meridional comatic aberrations (d), (e)) in the seventh working example.

Table 8 shows an aggregate of the values in the working examples corresponding to conditional formulae.

TABLE 8

| | | FIRST | SECOND | THIRD | FOURTH | FIFTH | SIXTH | SEVENTH |
|---|---|---|---|---|---|---|---|---|
| CONDITIONAL | | WORKING | WORKING | WORKING | WORKING | WORKING | WORKING | WORKING |
| FORMULAE | | EXAMPLE | EXAMPLE | EXAMPLE | EXAMPLE | EXAMPLE | EXAMPLE | EXAMPLE |
| (1) | f1/f2 | 2.21 | 1.63 | 0.95 | 0.99 | 1.32 | 1.02 | 1.33 |
| (2) | f/r22 | 0.62 | 0.34 | 0.15 | 0.57 | 1.05 | 0.33 | 0.96 |
| (3) | D4/f | 0.09 | 0.06 | 0.14 | 0.15 | 0.12 | 0.14 | 0.12 |
| (4) | r11/r12 | 0.92 | 0.90 | 0.60 | 0.49 | 0.59 | 0.61 | 0.59 |
| (5) | r21/f | 0.51 | 0.61 | 0.89 | 0.64 | 0.54 | 0.79 | 0.49 |
| (6) | ωD | 65.2 | 65.3 | 74.0 | 72.2 | 70.0 | 74.0 | 70.2 |

It should be noted that the present invention is limited to neither the embodiments nor the working examples described in the present specification but embraces, it is apparent to those skilled in the art from the embodiments described in the present specification and from the technical idea, other embodiments and modified examples.

### DESCRIPTION OF THE REFERENCE NUMERALS AND SYMBOLS

B operation button
B1 first spacer member
B2 second spacer member
BK lens block
BK1 first lens block
BK2 second lens block
D1, D2 display screen
L1a first object-side lens unit
L1b first image-side lens unit
L2a second object side lens unit
L2b second image-side lens unit
LN image capturing lens
LS lens substrate
LS1 first lens substrate
LS2 second lens substrate
LU image capturing device
MC image capturing device
PT plate
S aperture stop
SR image sensor
SS photoelectric converting unit
T mobile phone
UT lens block unit
UT1 first lens block unit
UT2 second lens block unit

What is claimed is:

1. An image capturing lens, when a lens block is defined as an optical element including a lens substrate serving as a parallel-plane plate and a lens unit formed on at least one of an object-side surface and an image-side surface of the lens substrate and having positive or negative power, materials of the lens unit and the lens substrate are different from each other, sequentially from an object side, comprising:
a first lens block having the positive power; and
a second lens block having the positive power,
wherein an aperture stop is provided on the object side of the first lens block or in an interior or the first lens block,
focal lengths of the first lens block and of the second lens block satisfy the following conditional formula (1), and
a surface, closest to the image side, of the second lens block is an aspherical surface being paraxial, taking a shape with a convex surface directed toward the image side and having at least one inflection point,
0.9<f1/f2<2.5 (1)
where,
f1: a focal length of the first lens block, and
f2: a focal length of the second lens block.

2. The image capturing lens according to claim 1, wherein an air space between the first lens block and the second lens block satisfies the following conditional formula (3),
0.03<D4/f<0.15 (3)
where,
D4: an on-optical-axis air space between the first lens block and the second lens block, and
f: a synthesized focal length of the whole image capturing lens system.

3. The image capturing lens according to claim 1 or 2, wherein a paraxial radius of curvature of an optical surface of the first lens block satisfies the following conditional formula (4),
0.3<r11/r12<1.0 (4)
where,
r11: a paraxial radius of curvature of a surface, closest to the object side, of the first lens block, and
r12: a paraxial radius of curvature, closest to the image side, of the first lens block.

4. The image capturing lens according to any one of claims 1 to 3, wherein the paraxial radius of curvature of a surface, closest to the object side, of the second lens block satisfies the following conditional formula (5),
0.45<r21/f<0.65 (5)
where,
r21: a paraxial radius of curvature of a surface, closest to the object side, of the second lens block, and
f: the synthesized focal length of the whole image capturing lens system.

5. The image capturing lens according to any one of claims 1 to 4, wherein the object-side surfaces of the second lens block have the same sign with respect to gradients of tangential lines of shapes of the lens surfaces in regions within effective diameters exclusive of the centers of the lenses.

6. The image capturing lens according to any one of claims 1 to 5, wherein the image capturing lens is used for forming an image of light of a subject on the image capturing surface of the image capturing element and satisfies the following conditional formula (6),
ωD≧65° (6)
where,
ωD: an overall angle of view, at an opposite angle, of the image capturing element.

7. The image capturing lens according to any one of claims 1 to 6, wherein the aperture stop is disposed on the lens substrate of the first lens block.

8. The image capturing lens according to any one of claims 1 to 7, wherein the image capturing lens involves using at least two types of resin materials.

9. The image capturing lens according to claim 8, wherein inorganic particles, of which a particle size is equal to or smaller than 30 nanometers, are dispersed in at least one type of resin material.

10. An image capturing device comprising the image capturing lens according to any one of claims 1 to 9.
